(19) United States
(12) Patent Application Publication
(10) Pub. No.: US 2013/0208007 A1
(43) Pub. Date: Aug. 15, 2013

(54) POSITION-RELATED INFORMATION REGISTRATION APPARATUS, POSITION-RELATED INFORMATION REGISTRATION SYSTEM, POSITION-RELATED INFORMATION REGISTRATION AND DISPLAY SYSTEM, AND RECORDING MEDIUM

(71) Applicants: Hiroaki KUBO, Muko-shi (JP); Kaitaku OZAWA, Nishinomiya-shi (JP); Shoji IMAIZUMI, Shinshiro-shi (JP); Takeshi MINAMI, Amagasaki-shi (JP)

(72) Inventors: Hiroaki KUBO, Muko-shi (JP); Kaitaku OZAWA, Nishinomiya-shi (JP); Shoji IMAIZUMI, Shinshiro-shi (JP); Takeshi MINAMI, Amagasaki-shi (JP)

(73) Assignee: Konica Minolta Buisness Technologies, Inc., Chiyoda-ku (JP)

(21) Appl. No.: 13/761,478

(22) Filed: Feb. 7, 2013

(30) Foreign Application Priority Data
Feb. 9, 2012 (JP) 2012-026052

(51) Int. Cl. G06F 17/30; G06T 11/60

(52) U.S. Cl. CPC G06F 17/30554; G06T 11/60
USPC 345/633; 707/722

(57) ABSTRACT

A position-related information registration and display system can register position-related information in a position-related information management server using a first terminal, and display an air tag based on the position-related information on a second data terminal including an imaging unit. The first data terminal extracts a search keyword from content displayed on a first display unit, accesses a keyword information storage unit, acquires a corresponding position information piece that is a position information piece corresponding to the search keyword extracted from the content, and transmits a registration request in addition to the content and the corresponding position information piece to the position-related information management server. The second data terminal acquires a position-related information piece corresponding to a location where the imaging unit performs imaging, from the position-related information management server, and displays an air tag based on the acquired position-related information piece in a superimposed manner in a captured image.

This application is based on Japanese Patent Application No. 2012-026052 filed on Feb. 9, 2012, the contents of which are hereby incorporated by reference.

### BACKGROUND OF THE INVENTION

1. Technical Field

The present invention relates to a position-related information registration apparatus for registering position-related information (e.g., air tag information) in a position-related information management server (e.g., air tag information management server) and to a technique related thereto.

2. Related Art

As an example of application software using augmented reality technology, there is application software called “Sekai Camera (registered trademark)”. This application software is installed and used in, for example, personal digital assistants such as smartphones.

If, during running of this application software, a user of a personal digital assistant captures an image of the surrounding area using an imaging unit built into the personal digital assistant, additional information (also called “air tag information”) that is associated with each target object such as a building in the shooting location is visualized and displayed on the captured image in a superimposed manner.

Specifically, “air tag information” of each target object is associated with position information (position information obtained from the Global Positioning System (GPS)) of the target object and recorded in a position-related information management server. Note that the “air tag information” is also referred to as “position-related information”, given that it is information registered in association with the position information. A personal digital assistant can acquire its current location using a built-in GPS unit. When a request to transmit air tag information is given from the personal digital assistant to the position-related information management server together with information about the current location of the personal digital assistant, the position-related information management server transmits “air tag information” regarding the vicinity of the current location of the photographer to the personal digital assistant that made the request. The personal digital assistant displays the received air tag information (specifically, an “air tag” obtained by visualizing the air tag information) in the image captured by the imaging unit, superimposed on a target object portion of the captured image. As a result, the “air tag” is displayed superimposed on a building or the like in the captured image.

Note that a technique for registering various types of contents in association with position information (GPS information) has also been proposed (see Japanese Patent Application Laid-Open No. 2010-026546).

The aforementioned conventional technique, however, requires that the current location of a personal digital assistant be recognized using a GPS unit. Specifically, the technique requires that GPS information be attached to an air tag, and GPS information in a given location is acquired by the GPS unit actually being present in “that location”. If the GPS unit is not present in “that location”, the GPS unit is not able to acquire the position information (GPS information) of “that location” and thus it is difficult to generate air tag information regarding “that location”. In this way, generation of the air tag information associated with GPS information is not always easy. In other words, registration of air tag information (position-related information) in the position-related information management server is not always easy.

### SUMMARY OF THE INVENTION

It is an object of the present invention to provide a position-related information registration apparatus capable of registering position-related information that includes position information with relative ease, and a technique related thereto.

According to a first aspect of the present invention, a position-related information registration and display system in which position-related information is registered in a position-related information management server on a network by a first data terminal, and an air tag based on the position-related information is displayable on a second data terminal that includes an imaging unit. The first data terminal includes a first display unit configured to display content to be registered, an extraction unit configured to extract a search keyword from the content displayed on the first display unit, a first acquisition unit configured to access a keyword information storage unit and acquire a corresponding position information piece that is a position information piece corresponding to the search keyword extracted from the content, the keyword information storage unit storing search keywords in association with position information pieces, and a registration control unit configured to transmit a registration request in addition to the content and the corresponding position information piece to the position-related information management server, the registration request being a request to register information in which the content is associated with the corresponding position information piece as a position-related information piece regarding the content. The position-related information management server includes a reception unit configured to receive the position-related information piece in addition to the registration request from the first data terminal, and a storage unit in which the position-related information piece that has been received is registered. The second data terminal includes the imaging unit, a second display unit configured to display an image captured by the imaging unit, a second acquisition unit configured to acquire a position-related information piece that corresponds to a location where the imaging unit performs imaging, from the position-related information management server, and a display control unit configured to display an air tag in a superimposed manner in the captured image, the air tag being based on the position-related information piece acquired by the second acquisition unit.

According to a second aspect of the present invention, a position-related information registration system for registering position-related information in a position-related information management server, includes a display unit configured to display content to be registered, an extraction unit configured to extract a search keyword from the content displayed on the display unit, an acquisition unit configured to access a keyword information storage unit and acquire a corresponding position information piece that is a position information piece corresponding to the search keyword extracted from the content, the keyword information storage unit storing search keywords in association with position information pieces, and a registration control unit configured to transmit a registration request in addition to the content and the corresponding position information piece to the position-related information management server, the registration request being a request to register information in which the content is associated with the corresponding position information piece as a position-related information piece regarding the content, and register the position-related information piece in the position-related information management server.

According to a third aspect of the present invention, a position-related information registration apparatus for registering position-related information in a position-related information management server, includes an acquisition unit configured to access a keyword information storage unit and acquire a corresponding position information piece that is a position information piece corresponding to a search keyword that is extracted from content to be registered, the keyword information storage unit storing search keywords in association with position information pieces, and a registration control unit configured to transmit a registration request in addition to the content and the corresponding position information piece to the position-related information management server, registration request being a request to register information in which the content is associated with the corresponding position information piece as a position-related information piece regarding the content, and register the position-related information piece in the position-related information management server.

According to a fourth aspect of the present invention, a non-transitory computer-readable recording medium that records a program for causing a computer to execute the steps of a) accessing a keyword information storage unit and acquiring a corresponding position information piece that is a position information piece corresponding to a search keyword extracted from content to be registered, the keyword information storage unit storing search keywords in association with position information pieces, and b) transmitting a registration request in addition to the content and the corresponding position information piece to a position-related information management server, the registration request being a request to register information in which the content is associated with the corresponding position information piece as a position-related information piece regarding the content, and registering the position-related information piece in the position-related information management server.

According to a fifth aspect of the present invention, a position-related information registration system for registering position-related information in a position-related information management server, includes a display unit configured to display content to be registered, an extraction unit configured to extract a search keyword from the content displayed on the display unit, a transmission unit configured to transmit a search request in addition to the search keyword to the position-related information management server, the search request being a request to search for a corresponding position information piece that is a position information piece corresponding to the search keyword extracted from the content, an acquisition unit configured to, based on a search result from the position-related information management server, acquire position information that is included in a position information piece that contains the search keyword among a plurality of position-related information pieces that have been registered in the position-related information management server, as the corresponding position information piece, and a registration control unit configured to transmit a registration request in addition to the content and the corresponding position information piece to the position-related information management server, the registration request being a request to register information in which the content is associated with the corresponding position information piece as a new position-related information piece regarding the content, and register the new position-related information piece in the position-related information management server.

According to a sixth aspect of the present invention, a position-related information registration apparatus for registering position-related information in a position-related information management server, includes a transmission unit configured to transmit a search request in addition to a search keyword that is extracted from content to be registered to the position-related information management server, the search request being a request to search for a corresponding position information piece that is a position information piece corresponding to the search keyword, an acquisition unit configure to, based on a search result from the position-related information management server, acquire position information that is included in a position-related information piece that contains the search keyword among a plurality of position-related information pieces that have been registered in the position-related information management server, as the corresponding position information piece, and a registration control unit configured to transmit a registration request in addition to the content and the corresponding position information piece to the position-related information management server, the registration request being a request to register information in which the content is associated with the corresponding position information piece as a new position-related information piece regarding the content, and register the new position-related information piece in the position-related information management server.

According to a seventh aspect of the present invention, a non-transitory computer-readable recording medium that records a program for causing a computer to execute the steps of a) transmitting a search request in addition to a search keyword that is extracted from content to be registered to the position-related information management server, the search request being a request to search for a corresponding position information piece that is a position information piece corresponding to the search keyword, b) based on a search result from the position-related information management server, acquiring position information that is included in a position-related information piece that contains the search keyword among a plurality of position-related information pieces that have been registered in the position-related information management server, as the corresponding position information piece, and c) transmitting a registration request in addition to the content and the corresponding position information piece to the position-related information management server, the registration request being a request to register information in which the content is associated with the corresponding position information piece as a new position-related information piece regarding the content, and registering the new position-related information piece in the position-related information management server.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates a position-related information registration system according to a first embodiment.

FIG. 2 is a functional block diagram illustrating a schematic configuration of a personal digital assistant.

FIG. 3 illustrates geographic word management information.

FIG. 4 illustrates operations according to the first embodiment.

FIG. 5 illustrates an example of the display of content on a personal digital assistant.

FIG. 6 illustrates the result of geographic word extraction (search).

FIG. 7 illustrates the result of acquisition of position information and the like for a plurality of geographic keywords.

FIG. 8 illustrates a screen for confirming registration content.

FIG. 9 illustrates a position-related information registration system according to a second embodiment.

FIG. 10 illustrates air tag management information.

FIG. 11 illustrates operations according to the second embodiment.

FIG. 12 illustrates the addition of underlines in the content.

FIG. 13 illustrates a position-related information registration system according to a third embodiment.

FIG. 14 is a functional block diagram illustrating a schematic configuration of an MFP (image forming apparatus).

FIG. 15 illustrates an overview of a maintenance operation.

FIG. 16 illustrates operations according to the third embodiment.

FIG. 17 illustrates air tag management information (before registration).

FIG. 18 illustrates an example of the display of content on a personal digital assistant.

FIG. 19 illustrates the addition of underlines in the content.

FIG. 20 illustrates a screen for confirming registration content.

FIG. 21 illustrates entry of maintenance results.

FIG. 22 illustrates air tag management information (after registration).

FIG. 23 illustrates a configuration according to a variation.

### DETAILED DESCRIPTION OF THE PREFERRED EMBODIMENTS

Hereinafter, embodiments of the present invention will be described with reference to the drawings.

### 1. First Embodiment

1-1. Overview of Configuration

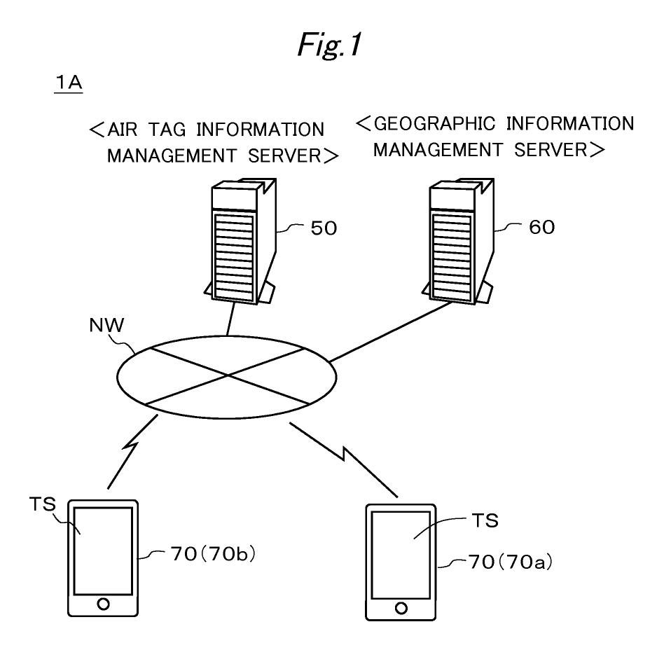

FIG. 1 illustrates an air tag information registration system (position-related information registration system) 1 (specifically, 1A) according to a first embodiment. As illustrated in FIG. 1, this air tag information registration system 1A includes an air tag information management server 50, a geographic information management server 60, and a plurality of personal digital assistants 70 (specifically, 70a, 70b, and so on).

The personal digital assistants 70 are each connected to the air tag information management server 50 and the geographic information management server 60 via a network NW. The network NW is, for example, a local area network (LAN) or the Internet. The mode of connection to the network NW may be cable connection or wireless connection. For example, the air tag information management server 50 and the geographic information management server 60 are connected by cable to the network NW, and the personal digital assistants 70 are wirelessly connected to the network NW.

The air tag information management server 50 is a server computer that manages air tag information for each target object, and specifically manages air tag information that includes position information (position information obtained from the Global Positioning System (GPS)) or the like. Because the “air tag information” is information associated with position information, it is also referred to as “position-related information”. Similarly, the air tag information management server 50 is also referred to as “position-related information management server 50”. The air tag information registration system 1 is also referred to as “position-related information registration system 1”. Note that the air tag information management server 50 includes a communication unit (not shown) that communicates with the personal digital assistants 70 or the like, and a storage unit (not shown) in which the position-related information or the like is stored.

The geographic information management server 60 is a server computer that manages position information (position information obtained from the GPS) for each geographic keyword, which will be described later.

Note that the air tag information registration system 1A can also be referred to as “air tag information management system” that manages and utilizes air tag information using the server 50 or the like. The personal digital assistants 70 are also referred to as “position-related information registration apparatuses”.

1-2. Configuration of Personal Digital Assistant 70

Next is a description of the configuration of the personal digital assistants 70.

The personal digital assistants 70 are portable information input/output terminal apparatuses that are capable of network communication with other apparatuses. Examples of the personal digital assistants 70 include smartphones and tablet terminals. The personal digital assistants 70 may, for example, be electronic document reading apparatuses or electronic paper reading apparatuses.

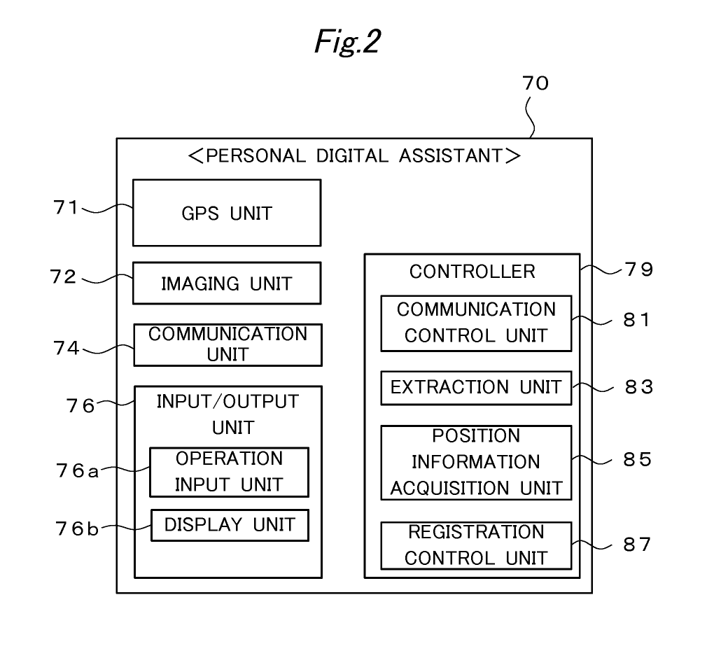

FIG. 2 is a functional block diagram illustrating a schematic configuration of a personal digital assistant 70.

As illustrated in the functional block diagram in FIG. 2, the personal digital assistant 70 includes, for example, a GPS unit 71, an imaging unit 72, a communication unit 74, an input/output unit 76, and a controller 79, and realizes various types of functions by operating these units in combination.

The GPS unit 71 is a processing unit configured to determine positions using the Global Positioning System (GPS).

The imaging unit 72 is configured by an optical element such as a lens, a photoelectric conversion element such as a CCD, and the like. The imaging unit 72 is capable of acquiring an image in which a target object around the personal digital assistant 70 has been captured as a subject.

The communication unit 74 is capable of network communication via the network NW. This network communication uses various types of protocols such as Transmission Control Protocol/Internet Protocol (TCP/IP). Using the network communication enables the personal digital assistant 70 to exchange various types of data with a desired party.

The input/output unit 76 includes an operation input unit 76a that receives input to the personal digital assistant 70, and a display unit 76b that displays and outputs various types of information. This personal digital assistant 70 is provided with a touch screen TS (see FIG. 1) that is constituted by embedding a piezoelectric sensor or the like in a liquid crystal display panel. This touch screen TS functions as part of the operation input unit 76a, and also functions as part of the display unit 76b.

The controller 79 is a control device that is built into the personal digital assistant 70 and performs overall control of the personal digital assistant 70. The controller 79 is configured as a computer system that includes, for example, a CPU and various types of semiconductor memories (RAM and ROM). The controller 79 realizes various types of processing units by the CPU executing a predetermined software program (hereinafter, also simply referred to as a “program”) PG1 stored in a storage unit (e.g., semiconductor memory). Note that the program PG1 may be installed in the personal digital assistant 70 via a portable recording medium such as a USB memory (in other words, various types of computer-readable non-transitory recording media), or via the network NW.

The program PG1 is application software using augmented reality technology and also realizes various functions related to augmented reality. The program PG1 also realizes, for example, the function of registering air tag information AJ in the air tag information management server 50. The description of the present embodiment focuses on this registration function.

Specifically, as illustrated in FIG. 2, the controller 79 realizes various types of processing units that include a communication control unit 81, an extraction unit 83, a position information acquisition unit 85, and a registration control unit 87.

The communication control unit 81 is a processing unit configured to control communication operations with the air tag information management server 50, the geographic information management server 60, and the like in cooperation with the communication unit 74 or the like.

The extraction unit 83 is a processing unit configured to extract search keywords from content (specifically, data of the content) CN displayed on the display unit 76b built into the personal digital assistant 70.

The position information acquisition unit 85 is a processing unit configured to acquire position information PD that is to be associated with the content CN. Specifically, the position information acquisition unit 85 is capable of acquiring information regarding the current location of the personal digital assistant 70 as the position information PD, using the GPS unit 71. The position information acquisition unit 85 is also capable of acquiring position information that is to be associated with the content CN and that is other than the current location of the personal digital assistant 70, as the position information PD. Specifically, as will be described later, the position information acquisition unit 85 is capable of accessing the geographic information management server 60 and acquiring position information (also referred to as “corresponding position information”) PD that corresponds to each search keyword (e.g., geographic keyword) from the geographic information management server 60.

The registration control unit 87 is a processing unit configured to register air tag information AJ regarding the content CN in which the content CN is associated with the position information PD, in the air tag information management server 50.

Through the operations or the like performed by these processing units, the personal digital assistant 70 functions as an apparatus (position-related information registration apparatus) for registering air tag information AJ (position-related information in which the content CN is associated with the position information PD) in the air tag information management server 50.

1-3. Geographic Information Management Server 60

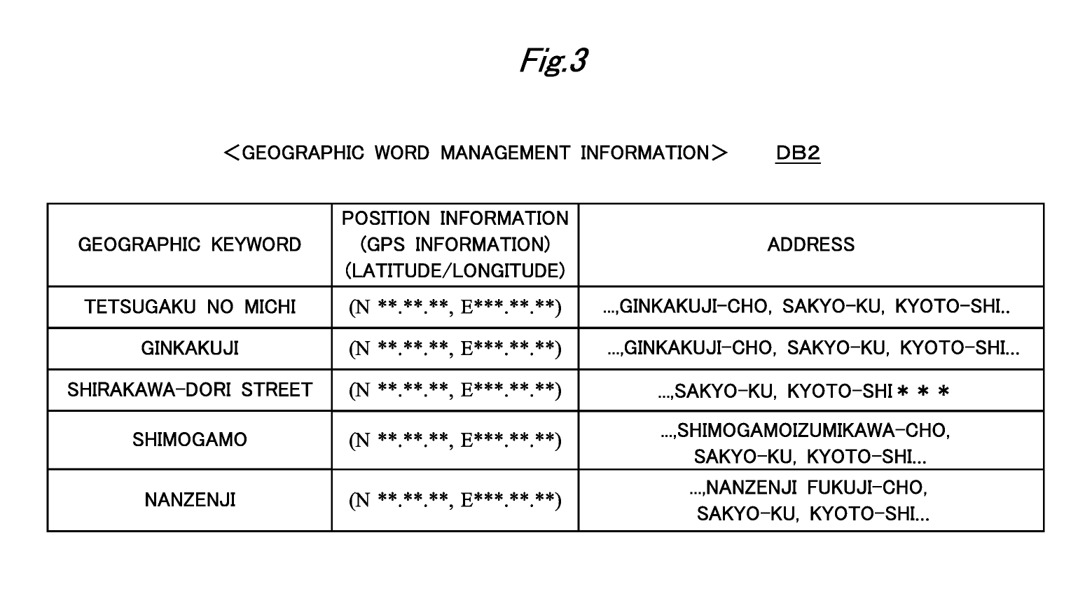

The geographic information management server 60 is a server computer that manages geographic information. Geographic word management information DB2 as illustrated in FIG. 3 is stored in the geographic information management server 60. In the geographic word management information DB2, geographic keywords and position information pieces (GPS information pieces) that correspond respectively to the geographic keywords are stored in association with each other. The geographic keywords are each stored in association with address information that corresponds to the geographic keyword. For example, the geographic keyword “Ginkakuji” is recorded in association with its position information (GPS information) and its address information. In this way, the correspondence of the geographic keyword, the position information, and the address information is stored in the geographic word management information DB2. The geographic word management information DB2 is also referred to as “geographic keyword list”.

In the first embodiment, geographic keywords in the content CN that is being displayed are used as search keywords to perform search processing using the geographic word management information DB2, and position information pieces or the like that correspond to the geographic keywords are acquired as a result. Note that the geographic information management server 60 functions as a keyword information storage unit configured to store a plurality of search keywords in association with their respective position information pieces.

The following is a detailed description of operations or the like performed in this system 1A.

1-4. Operations in System

Augmented reality is realized by execution of the program PG1 by the personal digital assistants 70. Specifically, when an operator of the personal digital assistant 70a has captured an image of the surroundings using the imaging unit 72 built into the personal digital assistant 70a, the image captured by the imaging unit 72 is displayed in real time on the display unit 76b (touch screen TS). At this time, an “air tag” (specifically, an air tag image) that is generated by visualizing additional information (air tag information) that is associated with a target object such as a building in the shooting location is displayed in a superimposed manner in the captured image.

Specifically, the “air tag information” of each target object is stored in association with position information (GPS information) of the target object in the air tag information management server 50 (specifically, air tag management information DB1 (not shown) in the server 50). Each personal digital assistant 70 is capable of acquiring its current location using the GPS unit 71 when capturing an image of a surrounding building or the like (surrounding target object). When a request to transmit air tag information is given together with information about the current location of the personal digital assistant 70 from the personal digital assistant 70 to the air tag information management server 50, the air tag information management server 50 transmits “air tag information” of the surroundings of the current location of photographer to the personal digital assistant 70 that made the request. The personal digital assistant 70 then superimposes and displays the received air tag information (specifically, an “air tag” obtained by visualizing the air tag information) on the target object portion in the image captured by the imaging unit 72. As a result, the “air tag” is displayed, superimposed on the building or the like in the captured image. Note that this display operation is controlled by a display control unit (not shown) or the like that is realized by the controller 79 of the personal digital assistant 70.

As described above, air tags are conventionally required to have GPS information added thereto, and the GPS information is acquired by the GPS unit actually being present in that location. Here, if the GPS unit is not present in that location, the GPS unit is not able to acquire position information, and thus it is difficult to generate air tag information based on the GPS information of that location.

In contrast, the air tag information registration system 1A according to the present embodiment makes it relatively easy to register air tag information by, for example, using the geographic information management server 60. The following is a detailed description of the registration operation.

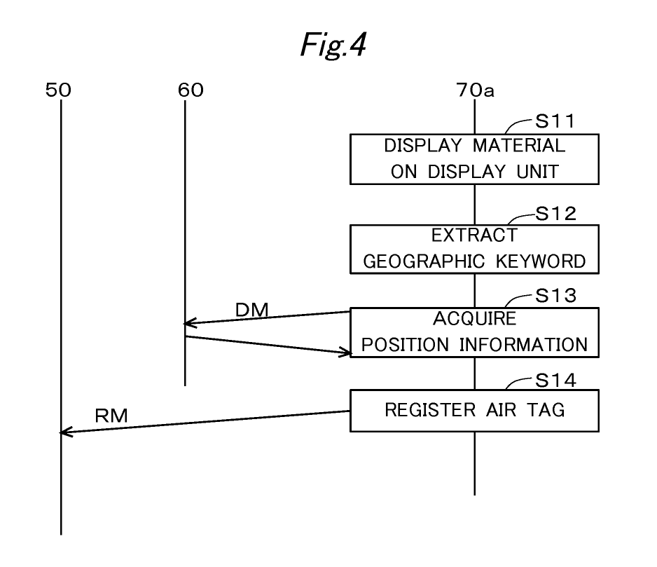

FIG. 4 illustrates operations performed in the air tag information registration system 1A. Here, a situation is assumed in which the program PG1 is executed by the personal digital assistant 70a, the “registration menu” has been selected by user operations, and the operation of registering desired content CN to be registered (registration operation) is executed.

First, in step S11 (FIG. 4), the personal digital assistant 70 (here, 70a) displays the content CN to be registered on the display unit 76b (touch screen TS) based on a user instruction. Examples of the content CN to be displayed include document data and image data. The content CN may be data that is stored in the storage unit of the personal digital assistant 70a, or data that is downloaded from a device different from the personal digital assistant 70a via the network (e.g., web content downloaded from a web server). Also, the content CN may be commonly distributed data or independently created data.

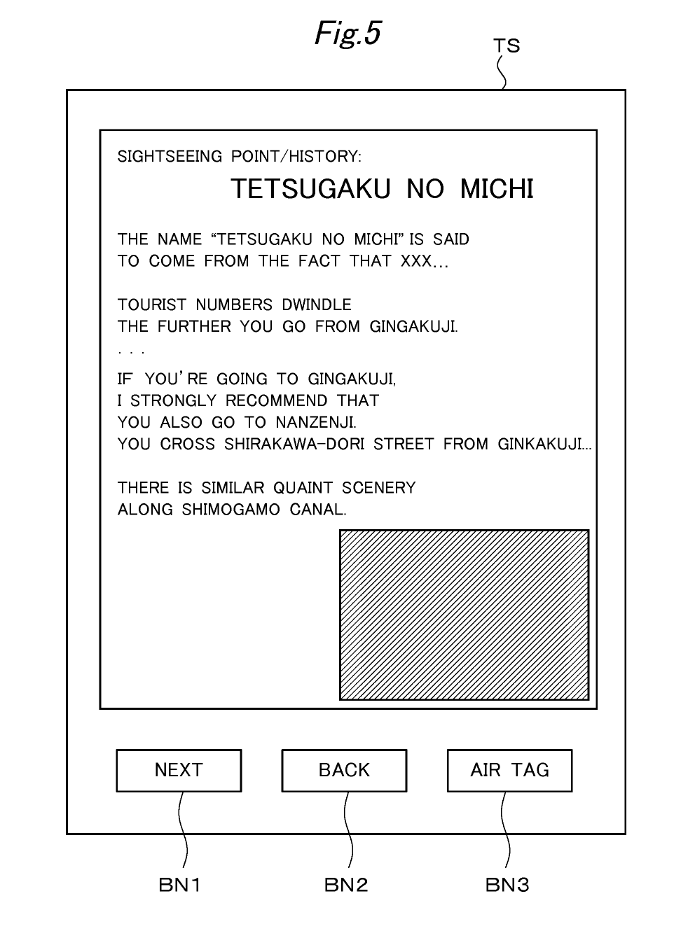

FIG. 5 illustrates an example of the display. FIG. 5 illustrates the display of content regarding a sight-seeing location (tourist information content) CN on the touch screen TS of the personal digital assistant 70a. Three buttons (specifically, a “NEXT” button BN1, a “BACK” button BN2, and an “AIR TAG” button BN3) are provided in the lower section of the screen in FIG. 5. These buttons are virtually realized on the tough screen TS by software (so-called software buttons). If the button BN1 is pressed, the next page is displayed, and if the button BN2 is pressed, the previous page is displayed. If the button BN3 is pressed, the operation of registering air tag information is executed.

When the button BN3 is pressed on the display screen in FIG. 5, search keywords are extracted from the content CN displayed on the touch screen TS of the personal digital assistant 70a (step S12). Specifically, the personal digital assistant 70a extracts geographic keywords as search keywords in cooperation with the geographic information management server 60. For example, the personal digital assistant 70a transmits text information on the page displayed on the touch screen TS to the geographic information management server 60. Then, the geographic information management server 60 searches the text information for words that match any of a plurality of geographic keywords in the geographic word management information DB2 (FIG. 3). The extraction result (search result) is transmitted from the geographic information management server 60 to the personal digital assistant 70a.

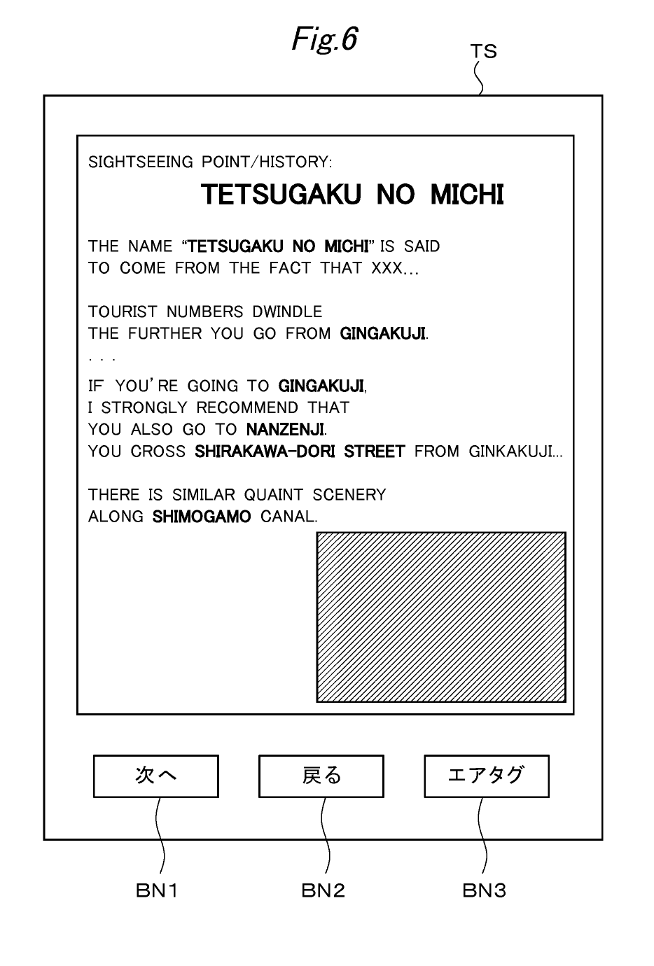

FIG. 6 illustrates the extraction result (search result). In FIG. 6, the geographic keywords extracted from the content CN displayed in FIG. 5 are indicated in boldface type. Specifically, words (geographic names) such as “Ginkakuji”, “Tetsugaku no Michi (Philosopher's Walk)”, and “Nanzenji” have been extracted as geographic keywords (search keywords).

Then, when the button BN3 is pressed again, this time position information that corresponds to each of the geographic keywords is acquired (step S13). Specifically, the personal digital assistant 70a accesses the geographic information management server 60 and acquires position information pieces PD that correspond to the geographic keywords (search keywords) from the geographic information management server 60.

More specifically, the personal digital assistant 70a transmits a search request DM to search for position information pieces that correspond respectively to the geographic keywords extracted from the content CN, together with the geographic keywords to the geographic information management server 60. Then, the geographic information management server 60 searches the geographic word management information DB2 for position information pieces PD that correspond to the respective geographic keywords, extracts the position information pieces PD, and transmits the extracted position information pieces PD to the personal digital assistant 70a. The personal digital assistant 70a acquires the position information pieces PD corresponding to the geographic keywords from the geographic information management server 60.

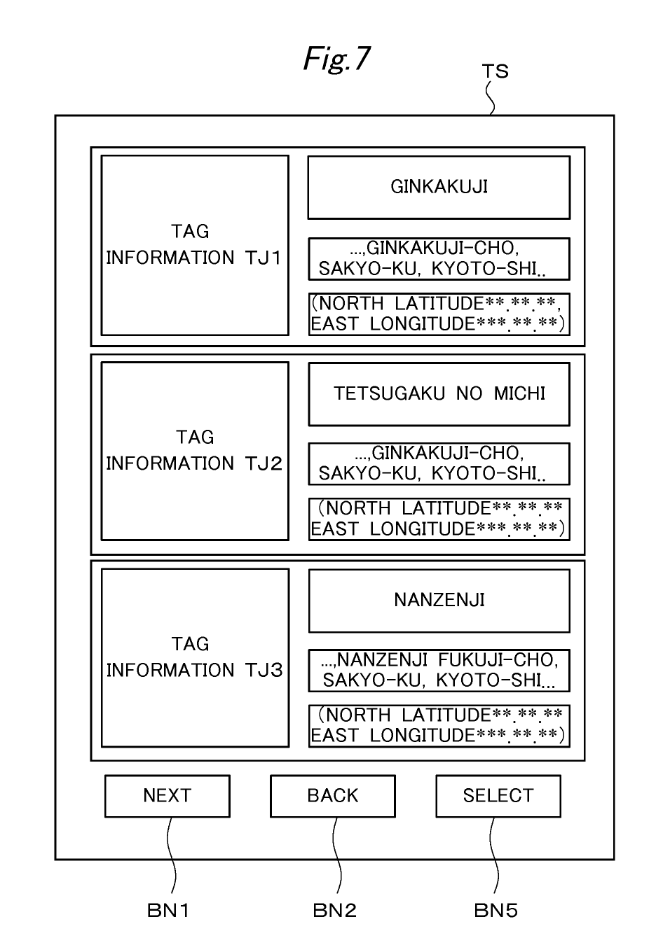

FIG. 7 illustrates the result of the acquisition of the position information pieces PD that correspond to a plurality of geographic keywords. In FIG. 7, a plurality of tab information pieces TJi (specifically, three tag information pieces TJ1, TJ2, and TJ3) regarding the geographic keywords are displayed as registration candidates. Specifically, the position information piece or the like that corresponds to the geographic keyword “Ginkakuji” is displayed as the tag information piece TJ1, the position information piece or the like that corresponds to the geographic keyword “Tetsugaku no Michi” is displayed as the tag information piece TJ2, and the position information piece or the like that corresponds to the geographic keyword “Nanzenji” is displayed as the tag information piece TJ3. More specifically, the geographic keywords are used as tag names of the tag information pieces. In consideration of the convenience of the user, not only the acquired position information PD but also address information that corresponds to the position information PD are displayed corresponding to each geographic keyword (tag name).

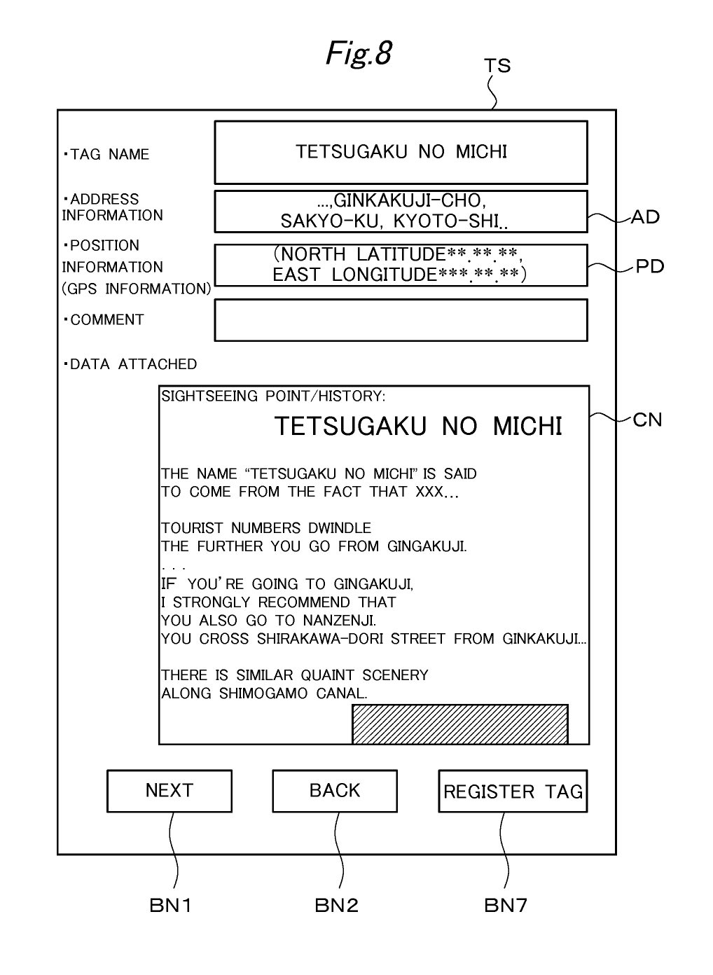

The operator selects the desired tag information piece from among these tag information pieces TJi. Specifically, the operator provisionally selects an area that corresponds to the desired tag information piece from among a plurality of display areas regarding the respective tag information pieces by pressing that area with his/her finger, and then presses a “SELECT” button BN5. For example, if having determined that the tag information piece TJ2 is the most appropriate tag information piece, the operator provisionally selects an area that corresponds to the tag information piece TJ2 in the second field from the top and then presses the SELECT button BN5. In response to this depression operation, a confirmation screen such as illustrated in FIG. 8 is displayed on the touch screen TS.

In the confirmation screen in FIG. 8, the tag name (geographic keyword), “Tetsugaku no Michi,” of the tag information piece TJ2 to be registered and the content CN to be recorded in association with that tag information piece are displayed. The confirmation screen also indicates that the position information PD and the address information AD are also to be registered in association with the content CN.

When a REGISTER TAG button BN7 is pressed after the display content in the confirmation screen in FIG. 8 has been confirmed, and a comment has been entered in the comment field if necessary, the personal digital assistant 70a generates an air tag information piece AJ based on the tag information piece TJ2. Specifically, the air tag information piece AJ that associates the content CN displayed in step S11 with the position information PD acquired in step S13 is generated by the personal digital assistant 70a. For example, the content CN may be associated with the position information PD as image data that is generated by visualizing target document data for each page. Then, the generated air tag information piece AJ (information including the tag name, the address information AD, the position information PD, comment information, and the content CN) is transmitted together with a registration request RM that requires the registration of the air tag information piece, from the personal digital assistant 70a to the air tag information management server 50. This registration request RM is an instruction that requires the registration of information (e.g., air tag information) that associates the content CN with the position information PD as position-related information regarding the content CN. In response to this registration request RM, the air tag information management server 50 additionally registers the received air tag information piece AJ as a new air tag information piece.

In this way, the personal digital assistant 70a (additionally) registers the air tag information piece AJ regarding the content CN in which the content CN is associated with the position information PD, in the air tag management information DB1 of the air tag information management server 50 (step S14).

As described above, the personal digital assistant 70 accesses the geographic information management server 60 and acquires a position information piece that correspond to a geographic keyword (search keyword) extracted from the content CN (step S13). Then, the personal digital assistant 70 registers the air tag information piece AJ regarding the content CN, in which the content CN is associated with the position information PD, in the air tag information management server 50 (step S14). Accordingly, the air tag information piece AJ that includes the position information PD can be generated relatively easily. In other words, the air tag information piece AJ including the position information PD in the air tag information management server 50 can be registered relatively easily.

After that, the registered air tag information piece AJ can be used by each personal digital assistant 70. For example, when a user actually visits the location that corresponds to the position information PD included in the air tag information piece AJ, the personal digital assistant 70 of the user can access the air tag information management server 50 to acquire the air tag information piece AJ and superimpose and display an air tag image regarding the air tag information piece AJ on the captured image. The personal digital assistant 70 of the user can also display thereon the content CN that is registered in association with the air tag information piece AJ through predetermined operations.

For example, it is possible for the operator to perform the operation of registering the air tag information piece AJ in step S10 (S11 to S14) at home in advance, and then when the operator subsequently goes on a trip, he/she can call up the previously registered air tag information piece AJ at his/her travel destination (on location) and reference the content CN (e.g., tourist information) that is associated with the air tag information piece AJ.

### 2. Second Embodiment

A second embodiment is a variation on the first embodiment. The following description focuses on differences from the first embodiment.

In the above-described first embodiment, the case is illustrated in which the position information (corresponding position information) PD that corresponds to a geographic keyword is acquired using the geographic word management information DB2 registered in the geographic information management server 60, and the air tag information piece AJ is generated based on the acquired position information PD.

In the second embodiment, the air tag information management server 50 is accessed, and it is determined whether or not an air tag information piece that corresponds to a search keyword is present within a plurality of air tag information pieces that have been registered in the air tag information management server 50. If there is an air tag information piece that corresponds to the search keyword, position information PD included that air tag information piece is acquired as position information that corresponds to the search keyword. In other words, a plurality of air tag information pieces that have been registered in the air tag information management server 50 are searched for an air tag information piece that includes a word that matches a specific search keyword, and position information in position-related information included in that air tag information is acquired as position information (corresponding position information) that corresponds to the specific search keyword. Then, the air tag information piece AJ regarding the content CN, in which the content CN to be registered is associated with the acquired position information PD, is registered in the air tag information management server 50.

That is, if an air tag information piece that has been registered in advance in association with the same keyword as a search keyword (registered air tag information) is present within the air tag information management server 50, the position information PD included in that registered air tag information piece is acquired, and the operation of registering a new air tag information piece is performed using that position information PD.

The following is a detailed description of this embodiment.

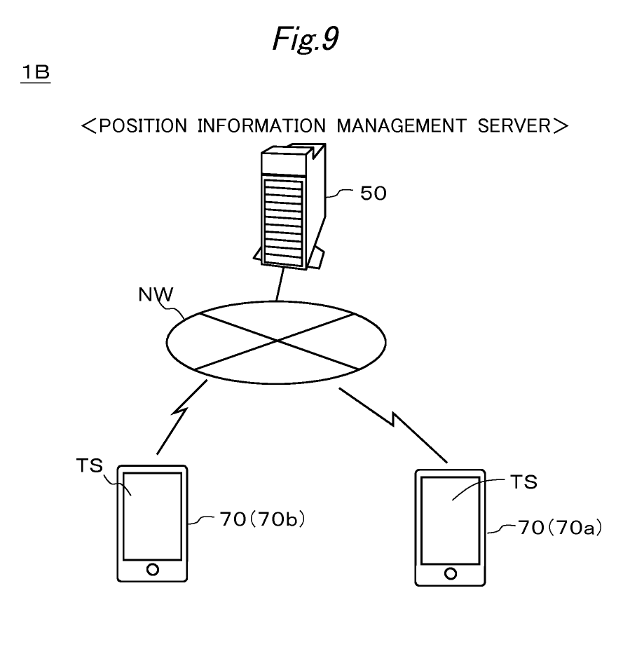

FIG. 9 illustrates an air tag information registration system 1B according to the second embodiment. As can be seen from comparison with FIG. 1, the air tag information registration system 1B according to the second embodiment is not provided with the geographic information management server 60. The other constituent elements of the air tag information registration system 1B are the same as in the air tag information registration system 1A according to the first embodiment.

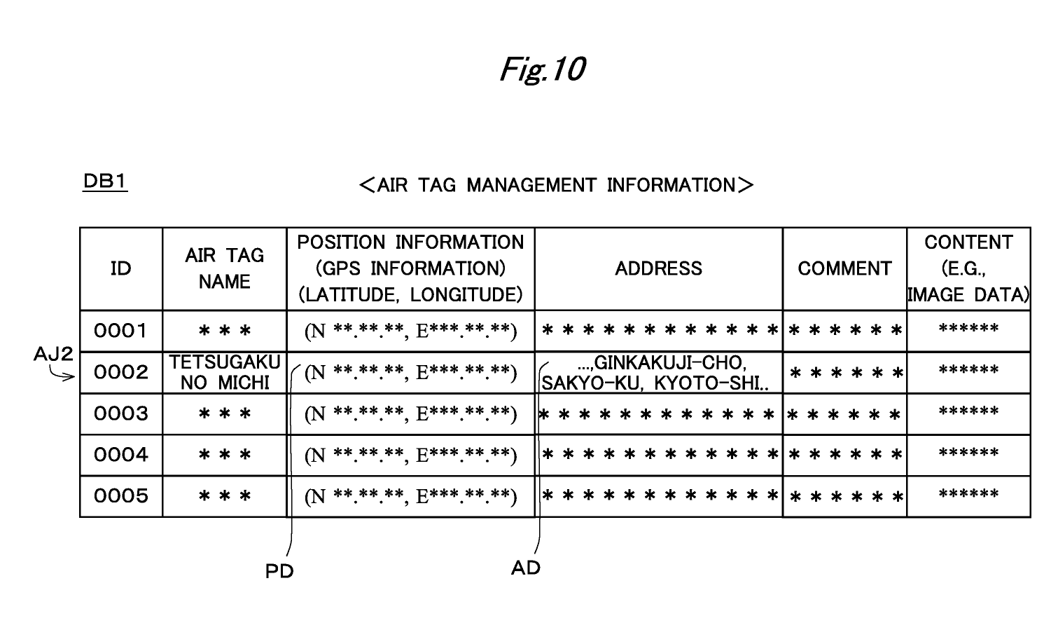

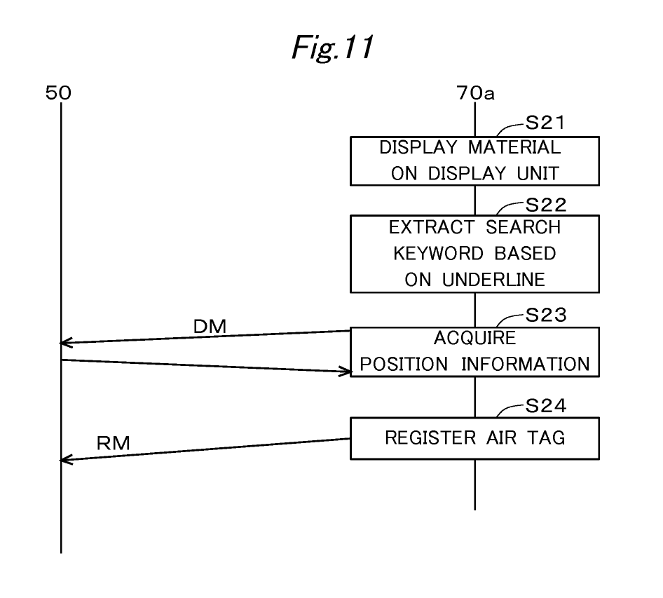

FIG. 10 illustrates air tag management information DB1 stored in the air tag information management server 50. The air tag management information DB1 is information for managing air tag information (position-related information). It is assumed that, at a point in time before the start of step S21 (FIG. 11), which will be described later, a plurality of air tag information pieces have already been registered in the air tag management information as illustrated in FIG. 10. Each air tag information piece has a plurality of item information pieces such as “ID (identifier),” “air tag name,” “position information (GPS information),” “address,” “comment,” and “content”.

These registered air tag information pieces are used as information targeted for each processing (search target information) in step S23, which will be described later, and this search target information is searched for an “air tag information piece that corresponds to a search keyword”. Each registered air tag information piece used as the search target information may be information that was registered in association with the position information PD of the location, when the personal digital assistant 70 and the operator were actually present in that location, or may be information that was registered in association with the position information PD of the location, as in the above-described first embodiment, when the personal digital assistant 70 and the operator were not actually present in that location. The registered air tag information pieces may be air tag information pieces that were registered by the same user, or may be air tag information pieces that were registered by different users.

FIG. 11 illustrates operations according to the second embodiment. In the second embodiment, the operations in FIG. 11 are executed, instead of the operations in FIG. 4.

Specifically, first, in step S21, the personal digital assistant 70a displays content CN to be registered on the display unit 76b (touch screen TS) as in step S11 (see FIG. 5).

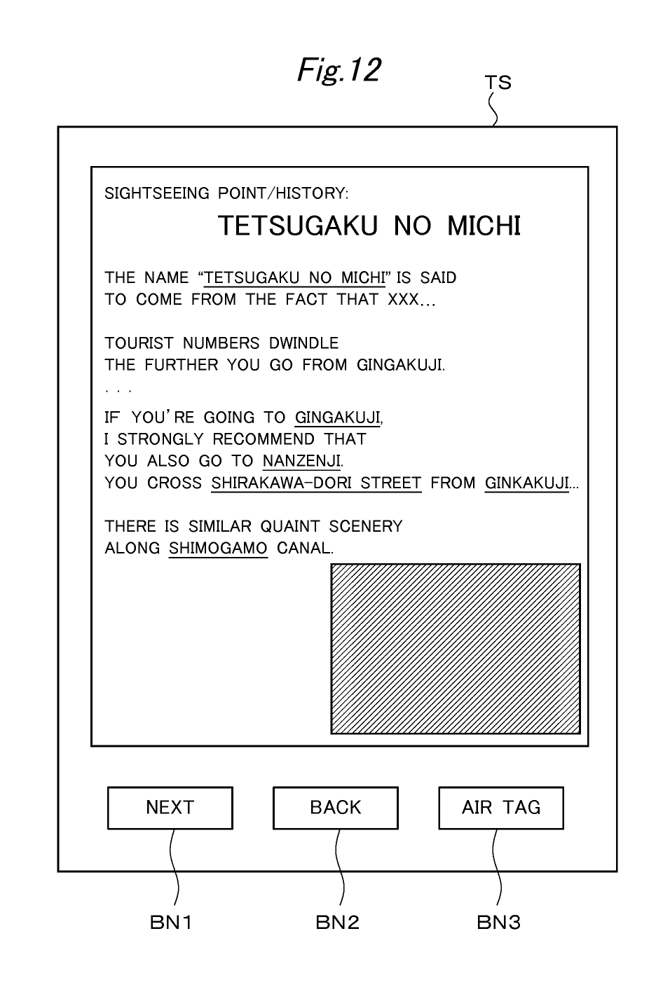

Next, the operator of the personal digital assistant 70a specifies a search keyword in the content CN displayed on the touch screen TS. Specifically, the operator performs an appropriate operation on the touch screen TS, using his/her finger, a touch pen, or the like (here, a substantially straight drag operation) so as to add specific marks (here, underlines) to desired character areas (see FIG. 12). Note that the processing for giving specific marks is not limited to the processing for giving underlines, and it may, for example, be processing for giving circles that enclose character areas and/or marking processing for coloring character areas with narrow rectangular marks of a specific color.

Thereafter, when a button BN3 on the display screen in FIG. 12 is pressed, the personal digital assistant 70a extracts search keywords based on the specific marks (here, underlines) from the content CN displayed on the touch screen TS of the personal digital assistant 70a (step S22). In other words, search keywords are extracted based on the user specification using the specific marks. For example, words such as “Tetsugaku no Michi,” “Ginkakuji,” and “Nanzenji” are extracted as search keywords.

Then, when the button BN3 is pressed again, this time the plurality of air tag information pieces that were registered in advance in the air tag management information DB1 (see FIG. 10) are searched for air tag information pieces that correspond to the search keywords.

For example, it is determined whether or not the search keyword “Tetsugaku no Michi” is included in specific items (specifically, “air tag name,” “address,” and/or “comment”) of the air tag information pieces that were registered in advance.

If the search keyword “Tetsugaku no Michi” is included in a specific item (e.g., “air tag name”) of a certain air tag information piece AJ2, the air tag information piece AJ2 is extracted as an air tag information piece that corresponds to the search keyword “Tetsugaku no Michi”. Then, position information PD included in this air tag information piece AJ2 is acquired as position information that corresponds to the search keyword “Tetsugaku no Michi” (step S23). Address information AD included in the air tag information piece AJ2 is also acquired as information that corresponds to the search keyword “Tetsugaku no Michi.”

This acquisition processing is realized by the personal digital assistant 70a coordinating with the air tag information management server 50. Specifically, the search keyword is transmitted together with a search request DM from the personal digital assistant 70a to the air tag information management server 50, and the air tag information management server 50 (specifically, a search unit (not shown) of the air tag information management server 50) determines, in response to the search request DM, whether or not the air tag management information DB1 includes an air tag information piece that corresponds to the search keyword. If an air tag information piece that corresponds to the search keyword is present in the air tag management information DB1, the air tag information management server 50 transmits position information PD, address information AD, and the like that were extracted from that air tag information piece, to the personal digital assistant 70a as a search result. Upon receiving the search result from the air tag information management server 50, the personal digital assistant 70a acquires, based on the search result, position information PD included in the air tag information piece that corresponds to the search keyword among the plurality of air tag information pieces, as position information that corresponds to the search keyword.

Similar operations are also executed for the other search keywords (such as “Ginkakuji” and “Nanzenji”). Here, a case is assumed in which only the single air lag information piece AJ2 is extracted as air tag information that corresponds to a plurality of search keywords (such as “Tetsugaku no Michi,” “Ginkakuji,” and “Nanzenji”). In this case, a confirmation screen such as illustrated in FIG. 8 is displayed.

Note that if a plurality of air tag information pieces have been extracted as air tag information pieces that corresponds to a plurality of search keywords, these air tag information pieces are displayed as selection candidates as in FIG. 7.

When the display content in the confirmation screen in FIG. 8 has been confirmed and the RESISTER TAG button BN7 has been pressed, the personal digital assistant 70a generates a new air tag information piece AJ20 (not shown). For example, in the case of using an air tag information piece AJ2 of a user UB different from the operator UA, a new air tag information piece AJ20 for the operator UA that is separate from that for the user UB is generated. Note that the present invention is not limited thereto, and an air tag information piece AJ2 of the same operator UA may be used to generate a new air tag information piece AJ20 for the user UA (e.g., new air tag information having an ID of 0006).

More specifically, the new air tag information piece AJ20 that associates the content CN displayed in step S21 with the position information PD acquired in step S23 is generated by the personal digital assistant 70a. Then, the air tag information piece AJ20 (information including the position information PD and the content CN) is transmitted together with a registration request RM from the personal digital assistant 70a to the air tag information management server 50. In response to the registration request RM, the air tag information management server 50 additionally registers the received air tag information piece AJ20 as a new air tag information piece.

In this way, the personal digital assistant 70a registers new air tag information AJ regarding the content CN, in which the content CN is associated with the position information PD, in the air tag information management server 50 (step S24).

As described above, the personal digital assistant 70a accesses the air tag information management server 50, acquires an air tag information piece AJ2 that corresponds to a search keyword from among a plurality of air tag information pieces that have been registered in the air tag information management server 50, and acquires position information PD that is included in the air tag information piece AJ2. The personal digital assistant 70a then registers a new air tag information piece AJ20 regarding the content CN, in which the content CN is associated with the position information PD, in the air tag information management server 50. Accordingly, the new air tag information piece AJ20 that includes the position information PD can be generated relatively easily. In other words, the new air tag information piece AJ20 including the position information PD in the air tag information management server 50 can be registered relatively easily.

In particular, even if the operator is not present in “that location,” the position information PD of “that location” can be acquired. This makes it possible to register air tag information including the position information PD very easily.

In the second embodiment, a mode is illustrated in which an air tag information piece that includes content that matches any of a plurality of keywords extracted from the content CN is searched for in step S23. That is, a mode in which an OR search is performed for a plurality of search keywords is illustrated. However, the present invention is not limited thereto. For example, a so-called AND search may be performed for a plurality of search keywords. More specifically, an air tag information piece that contains all search keywords (e.g., both “Kyoto” and “Tetsugaku no Michi”) may be searched for.

### 3. Third Embodiment

3-1. Overview

A third embodiment is a variation on the second embodiment. The following description focuses on differences from the second embodiment.

The third embodiment differs from the second embodiment in that the operation of registering information in the air tag information management server 50 or the like is executed mainly by an image forming apparatus 10 (specifically, 10x), instead of the personal digital assistants 70. In the third embodiment, content CN stored in the image forming apparatus 10x is also to be registered in association with position information PD in the air tag information management server 50.

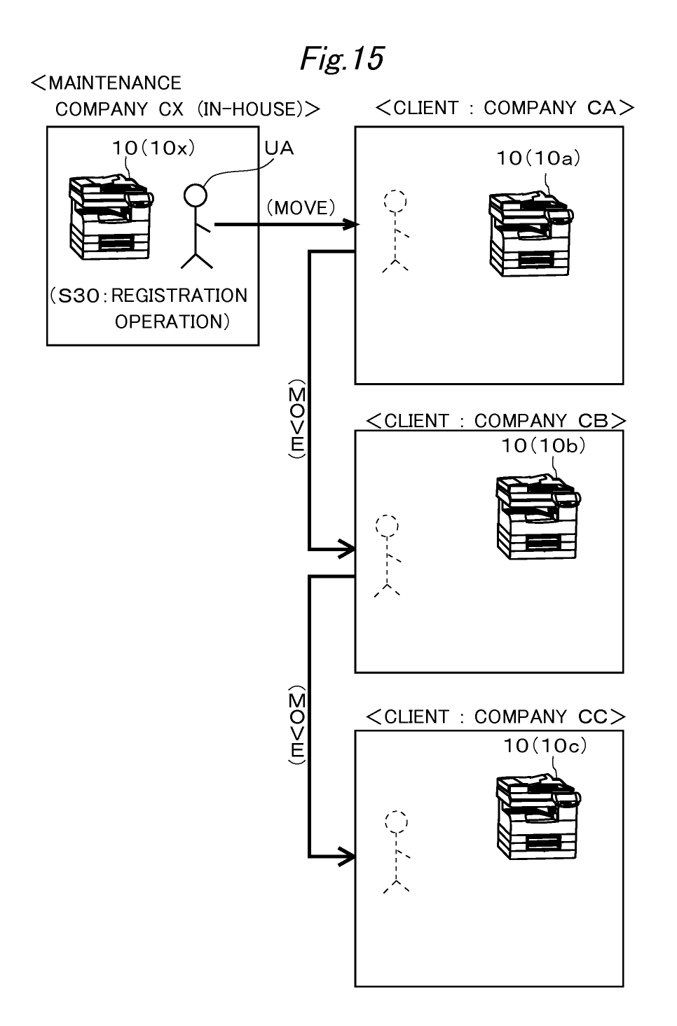

In the third embodiment, instead of materials on sight-seeing places, “maintenance sheets” for a plurality of image forming apparatuses 10a, 10b, and 10c (see FIG. 15) are illustrated as the content CN.

Here, the image forming apparatuses 10a, 10b, and 10c are maintenance target apparatuses targeted for maintenance by a maintenance operator UA. The “maintenance sheets” for the image forming apparatuses 10 are used when the maintenance operator UA of a supplier (e.g., retail company CX) performs maintenance of the image forming apparatuses 10a, 10b, and 10c delivered to clients (companies CA, CB, and CC). Specifically, a situation is assumed in which the maintenance operator UA performs an operation of preparing each maintenance sheet (specifically, operation of registering each maintenance sheet) in his/her own company (in the building of the company CX or the like) before visiting each client. In this registration operation, each maintenance sheet is registered in association with each air tag information piece. Thereafter, the operator UA, having actually arrived in a client's location, records a maintenance result on the “maintenance sheet” that is the content associated with the air tag information piece, by using a personal digital assistant 70 to call up the air tag information piece regarding the client, in the client's location.

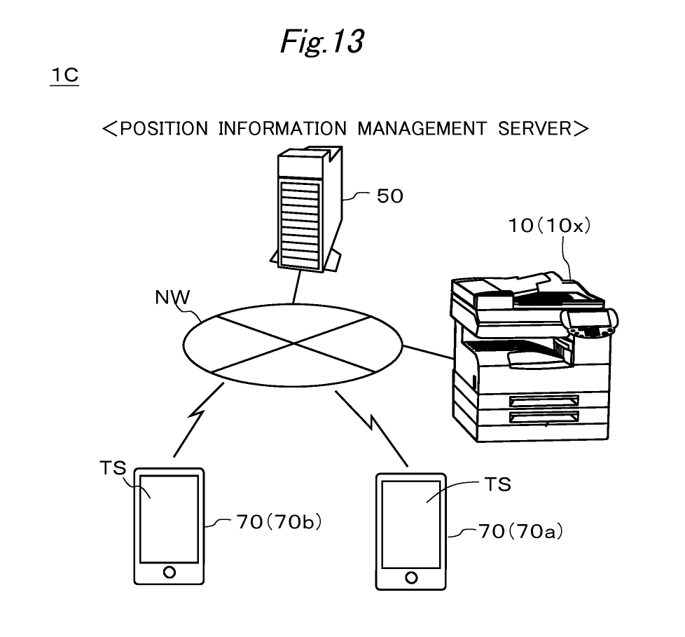

FIG. 13 illustrates an air tag information registration system 1C according to the third embodiment. As can be seen from comparison of FIG. 13 with FIG. 9, this system differs from the air tag information registration system 1B according to the second embodiment in that the image forming apparatus 10x is additionally provided.

3-2. Configuration of Image Forming Apparatus

Next is a description of the configuration of the image forming apparatus 10x. The image forming apparatus 10x is an element that constitutes the position-related information registration system 1C. The image forming apparatus 10x is also referred to as a “position-related information registration apparatus”.

In the present embodiment, a Multi-Functional Peripheral (MFP) is given as an example of the image forming apparatus 10x.

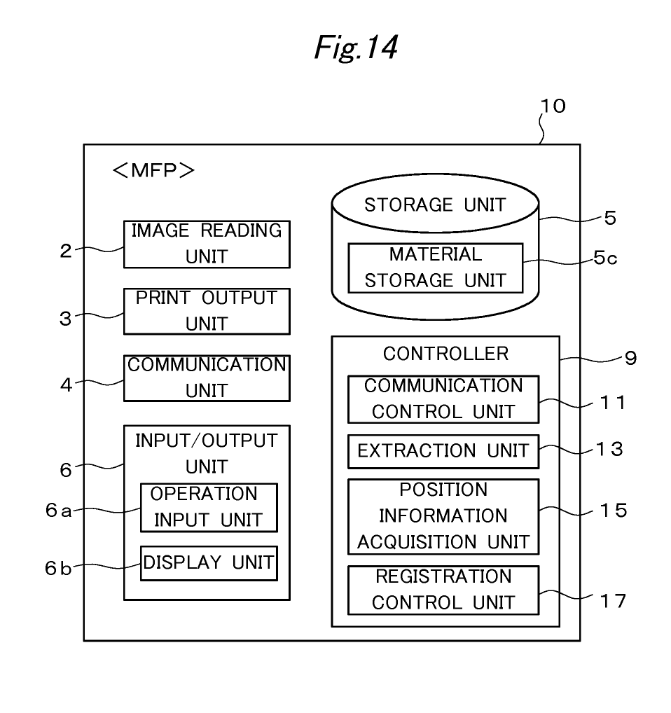

FIG. 14 is a functional block diagram illustrating a schematic configuration of the MFP 10 (specifically, 10x).

The MFP 10 is an apparatus having functions such as a scan function, a copy function, a facsimile function, and a box storage function (also referred to as a “Multi-Functional Peripheral”). Specifically, as illustrated in the functional block diagram of FIG. 14, the MFP 10 includes, for example, an image reading unit 2, a print output unit 3, a communication unit 4, a storage unit 5, an input/output unit 6, and a controller 9, and realizes various types of functions by operating these units in combination.

The image reading unit 2 is a processing unit that optically reads (i.e., scans) an original document that is placed at a predetermined position on the MFP 10, and generates image data of the original document (also referred to as an “original image” or a “scanned image”). The image reading unit 2 is also called a scan unit.

The print output unit 3 is an output unit that prints out an image on various types of media such as paper based on data regarding an object to be printed.

The communication unit 4 is a processing unit capable of facsimile communication via a public network or the like. The communication unit 4 is also capable of network communication via a network NW. In this network communication, various types of protocols such as TCP/IP (Transmission Control Protocol/Internet Protocol) are used, for example. Using the network communication enables the MFP 10 to exchange various types of data with a desired party.

The storage unit 5 is configured by a storage device such as a hard disk drive (HDD). Various types of material data (content CN) are stored in a material storage unit 5c of the storage unit 5. For example, “maintenance sheets” regarding respective MFPs that have been delivered to a plurality of clients are stored.

The input/output unit 6 includes an operation input unit 6a that receives input to the MFP 10, and a display unit 6b that displays and outputs various types of information.

The controller 9 is a control device that is built into the MFP 10 and performs overall control of the MFP 10. The controller 9 is configured as a computer system that includes, for example, a CPU and various types of semiconductor memories (RAM and ROM). The controller 9 implements various types of processing units by the CPU executing a predetermined software program (hereinafter, also referred to simply as a “program”) PG2 stored in the ROM (e.g., EEPROM). Note that the program PG2 may be installed in the MFP 10 via a portable recording medium such as a USB memory (in other words, various types of non-transitory computer-readable recording media), or via a network NW or the like.

Specifically, as illustrated in FIG. 14, the controller 9 implements various types of processing units that include a communication control unit 11, an extraction unit 13, a position information acquisition unit 15, and a registration control unit 17.

The communication control unit 11 is a processing unit configured to control communication operations with an air tag information management server 50, personal digital assistants 70, and the like in cooperation with the communication unit 4 or the like.

The extraction unit 13 is a processing unit configured to extract search keywords from content CN displayed on a display unit 76b that is built into the personal digital assistants 70.

The position information acquisition unit 15 is a processing unit configured to acquire position information that corresponds to a search keyword. Specifically, the position information acquisition unit 15 accesses the air tag information management server 50, acquires an air tag information piece that corresponds to each search keyword from among a plurality of air tag information pieces that have been registered in the air tag information management server 50, and acquires position information PD that is included in the acquired air tag information piece.

The registration control unit 17 is a processing unit configured to register a new air tag information piece AJ regarding the content CN, in which the content CN is associated with the position information PD, in the air tag information management server 50.

Through the operations or the like performed by these processing units, the MFP 10 (10x) functions as an apparatus for registering air tag information (including position information) in the air tag information management server 50 (i.e., position-related information registration apparatus).

The image forming apparatuses 10a, 10b, and 10c (see FIG. 15) other than the image forming apparatus 10x also have similar configurations. Note that in the present embodiment, the image forming apparatuses 10a, 10b, and 10c other than the image forming apparatus 10x are apparatuses targeted for maintenance and are not required to have the above-described registration function.

3-3. Operations

Next is a description of operations according to the third embodiment.

In the third embodiment, data for recording the results of maintenance of a plurality of image forming apparatuses 10 (e.g., 10a, 10b, and 10c) that have been delivered to a plurality of clients (data for recording maintenance results) is managed using the air tag information registration system 1C. It is assumed here that the data for recording the maintenance result of each image forming apparatus 10 is to be recorded on a “maintenance sheet” for each image forming apparatus 10. It is also assumed that the “maintenance sheet” is transformed into electronic data and stored as an electronic document (maintenance sheet data) in the image forming apparatus 10x (FIG. 15).

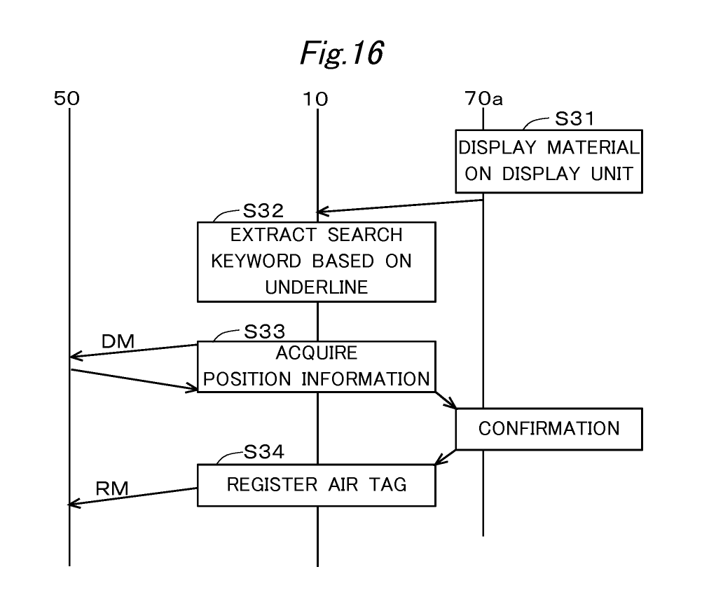

FIG. 16 illustrates operations according to the third embodiment. In the third embodiment, the operation of registering a maintenance sheet in FIG. 16 (operation of registering an air tag information piece that associates the maintenance sheet with the position information PD, in the air tag information management server 50) is executed, instead of the operations in FIG. 11 (step S30 (S31 to 34)).

The operations (maintenance sheet registration operation) in FIG. 16 are performed, for example, before a maintenance operator arrives in a client's location (specifically, for example, before the maintenance operator leaves his/her company office). The maintenance sheet registration operation according to the third embodiment is executed mainly by the image forming apparatus 10x.

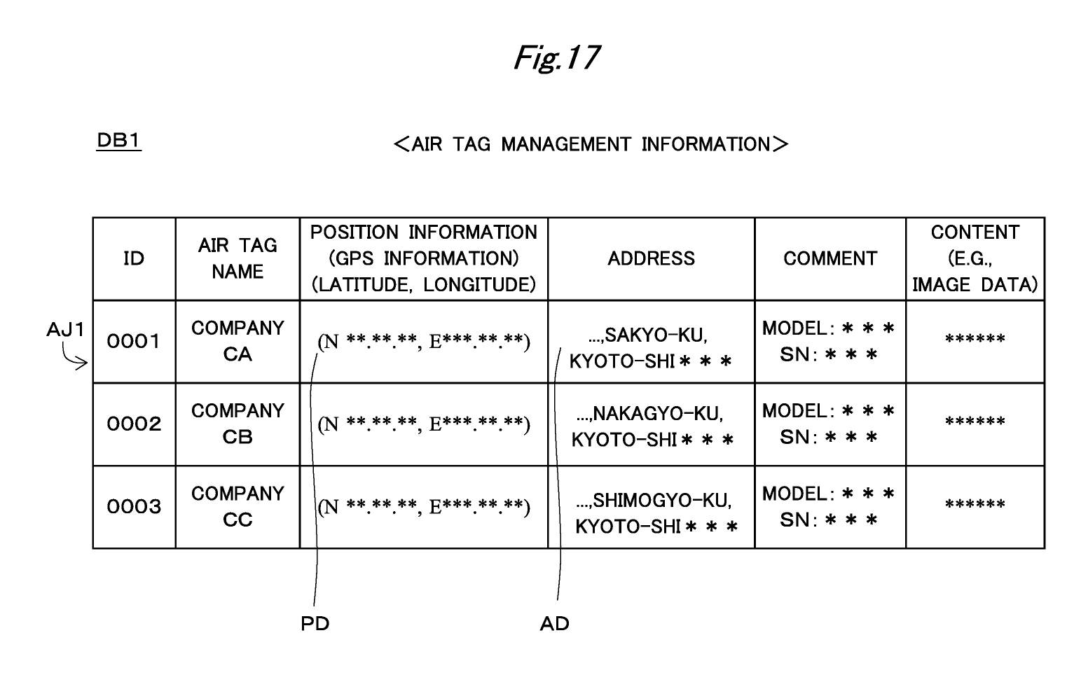

Here, in the third embodiment, it is assumed that a “preparatory registration operation of registering client position information in advance” has been performed prior to step S30 (see FIG. 16). This preparatory registration operation is performed, for example, when each image forming apparatus 10 is delivered to each client. Specifically, at the time of the delivery, position information PD is acquired using a personal digital assistant 70 (specifically, a GPS unit 71 of the personal digital assistant 70), and the operation of registering the acquired position information PD in association with delivery information (e.g., the company name of the client, the model of the delivered apparatus, and the serial number of the delivered apparatus) is performed in advance. It is thus assumed that the position information (GPS information) PD of each client company has been registered in advance in the DB1. FIG. 17 illustrates the preliminary registration of the position information PD or the like of each client company in the air tag management information DB1 in the air tag information management server 50.

Hereinafter, the operation of step S30 will be described with reference to FIG. 16 and the like.

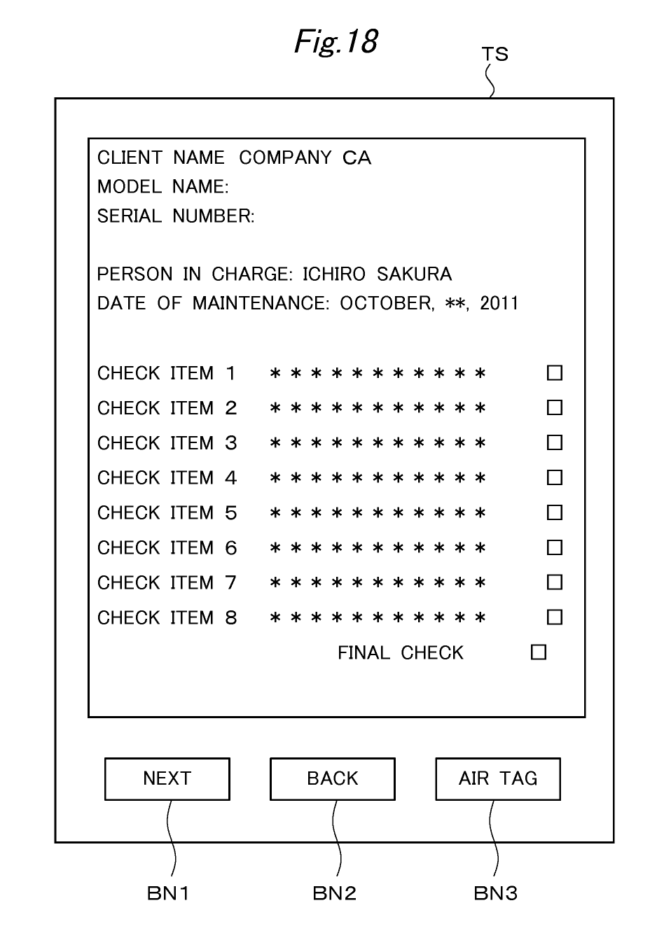

First, in step S31, the personal digital assistant 70a displays content CN to be registered on the display unit 76b (touch screen TS) based on user operations (see FIG. 18). For example, the content CN stored in a storage unit (box area) of the image forming apparatus 10x is downloaded from the image forming apparatus 10x via the network NW and displayed on the display unit 76b (touch screen TS) of the personal digital assistant 70a.

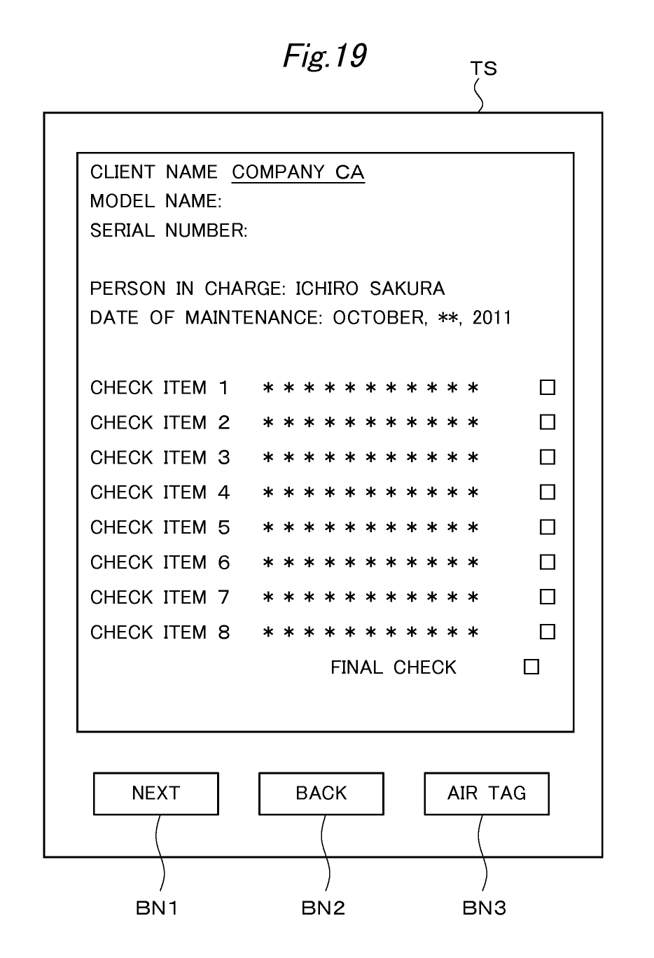

Next, the operator of the personal digital assistant 70a specifies a search keyword (e.g., proper noun for searching for client information) in the content CN displayed on the touch screen TS. Specifically, the operator adds a specific mark (here, an underline) to a desired character area by performing an appropriate operation (here, a substantially straight drag operation) in the touch screen TS, using his/her finger, a touch pen, or the like (see FIG. 19). FIG. 19 illustrates the addition of an underline to “Company CA” that is the name (company name) of the client (to which the apparatus was delivered).

Thereafter, when the button BN3 is pressed on the display screen in FIG. 19, a search keyword is extracted based on the specific mark (here, an underline) from the content CN displayed on the touch screen TS of the personal digital assistant 70a (step S32).

Specifically, the content CN (specifically, image data of the content) with the specific mark is transferred to the image forming apparatus 10x, and the image forming apparatus 10x extracts “Company CA” as a search keyword based on the transferred data. Although a mode in which the image forming apparatus 10x (specifically, the extraction unit 13) extracts a search keyword has been illustrated here, the present invention is not limited thereto. For example, as in the second embodiment, the personal digital assistant 70a (specifically, the extraction unit 83) may extract a search keyword.

Then, when the button BN3 is pressed again, this time a plurality of air tag information pieces that have been registered in advance in the air tag management information DB1 are searched for an air tag information piece that corresponds to the search keyword. For example, it is determined whether or not the search keyword “Company CA” is included in specific items (specifically, for example, “air tag name,” “address,” and/or “comment”) of the air tag information pieces that have been registered in advance. If the search keyword “Company CA” is included in a specific item (e.g., “air tag name”) of a certain air tag information piece AJ1, this air tag information piece AJ1 is extracted as an air tag information piece that corresponds to the search keyword “Company CA”. Then, position information PD included in the air tag information piece AJ1 is acquired as position information that corresponds to the search keyword “Company CA” (step S33). Also, address information AD included in the air tag information piece AJ1 is acquired as information that corresponds to the search keyword “Company CA”.

This acquisition processing is realized by the image forming apparatus 10x coordinating with the air tag information management server 50. Specifically, each search keyword is transmitted together with a search request DM from the image forming apparatus 10x to the air tag information management server 50, and the air tag information management server 50 determines whether or not an air tag information piece that corresponds to each search keyword is present in the air tag management information DB1. If an air tag information piece (e.g., AJ1) that corresponds to each search keyword is present in the air tag management information DB1, the air tag information management server 50 transmits the position information PD and the address information AD that have been extracted from that air tag information piece (e.g., AJ1) to the image forming apparatus 10x. The image forming apparatus 10x acquires, based on the received information, the position information PD that is included in the air tag information piece that corresponds to the search keyword among the plurality of air tag information pieces, as position information that corresponds to the search keyword. Similarly, the received address information AD is acquired as address information that corresponds to the search keyword.

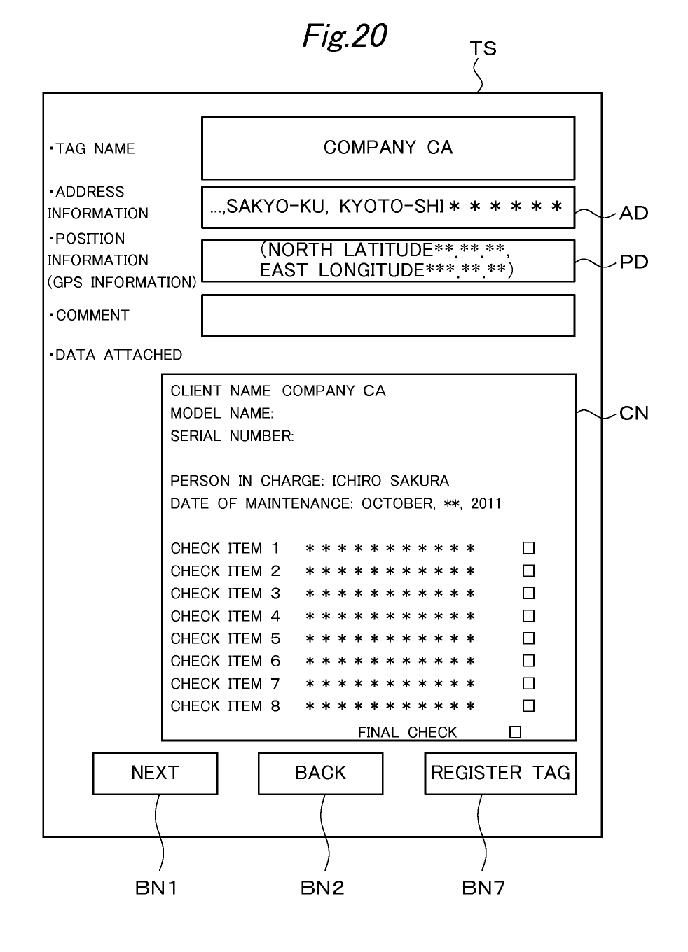

The image forming apparatus 10x transfers the received position information PD and the like to the personal digital assistant 70a, and the personal digital assistant 70a displays a confirmation screen as illustrated in FIG. 20 based on the position information PD and the like that have been transferred from the image forming apparatus 10x.

When the REGISTER TAG button BN7 is pressed after the display content in the confirmation screen in FIG. 20 has been confirmed, and a comment has been entered in the comment field if necessary, the personal digital assistant 70a transmits a registration request to the image forming apparatus 10x. Upon receiving the registration request, the image forming apparatus 10x generates a new air tag information piece AJ20 regarding the content CN and registers the new air tag information piece AJ20 in which the content CN is associated with the position information PD, in the air tag information management server 50 (step S34).

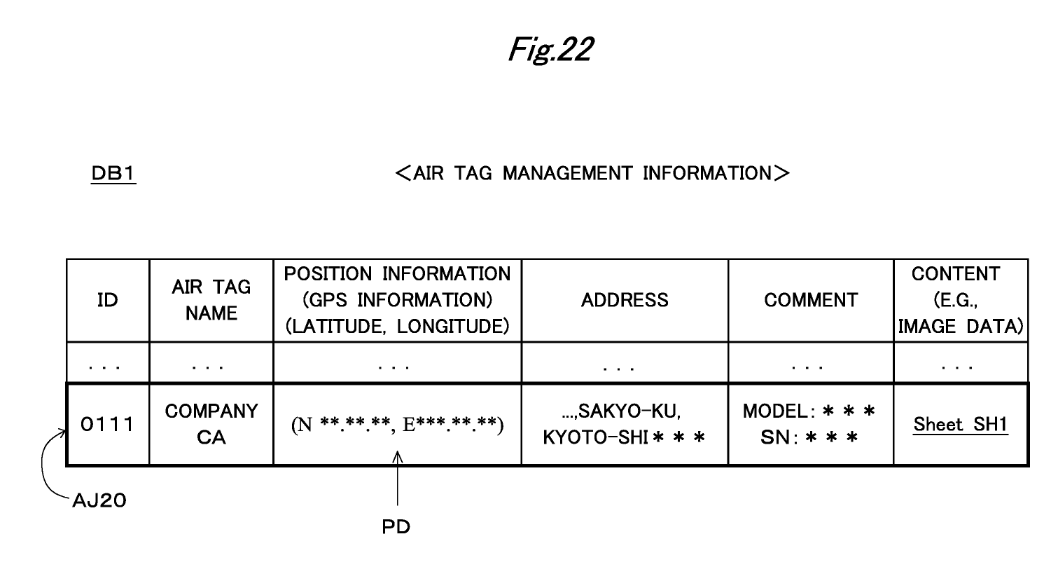

More specifically, the new air tag information piece AJ20 that associates the content CN displayed in step S31 with the position information PD acquired in step S33 is generated by the image forming apparatus 10x. Then, the new air tag information piece AJ20 is transmitted together with the registration request to register the new air tag information piece AJ20, from the image forming apparatus 10x to the air tag information management server 50. In response to this registration request, the air tag information management server 50 additionally registers the received air tag information piece AJ20 as a new air tag information piece AJ20 (see FIG. 22). FIG. 22 illustrates the newly registered air tag information piece AJ20. As illustrated in FIG. 22, in the air tag information piece AJ20, the position information PD that was included in the air tag information piece AJ1 is also registered as position information in the new air tag information piece AJ20. Also, a maintenance sheet SH1 is registered as content CN in the new air tag information piece AJ20.

If preparation for the maintenance of a plurality of image forming apparatuses 10 for a plurality of clients is carried out, the operation of the above-described step S30 may be performed repeatedly for these image forming apparatuses 10.

As described above, the image forming apparatus 10x accesses the air tag information management server 50, acquires the air tag information piece AJ1 that corresponds to a search keyword from among a plurality of air tag information pieces that have been registered in the air tag information management server 50, and acquires the position information PD included in the air tag information piece AJ1. Then, the image forming apparatus 10x registers the new air tag information piece AJ20 regarding the content CN in which the content CN is associated with the position information PD, in the air tag information management server 50.

Accordingly, in the case where the operator desires to register certain content CN in association with a certain location, even if the operator is not present in that location, the new air tag information piece AJ20 that includes the position information PD of that location can be generated relatively easily. In other words, the new air tag information piece AJ20 including the position information PD in the air tag information management server 50 can be registered relatively easily.

More specifically, the maintenance operator UA can register a maintenance sheet for an image forming apparatus 10 in-house before arriving in the client's location. By repeating similar operations, the maintenance operator UA can collectively register a plurality of maintenance sheets for a plurality of image forming apparatuses (e.g., 10a, 10b, and 10c) in-house before arriving in each client's location.

In particular, it is unnecessary for the maintenance operator to be actually present on site (client's location) when registering a maintenance sheet with an air tag. This allows the maintenance sheet registration operation to be performed before the operator arriving on site, thus improving the convenience of registration.

Then, after the maintenance sheets have been registered through the above-described operations (see FIG. 16), the operation of using air tags during maintenance is executed. That is, the operation of using air tags during maintenance of the image forming apparatuses 10 is performed.

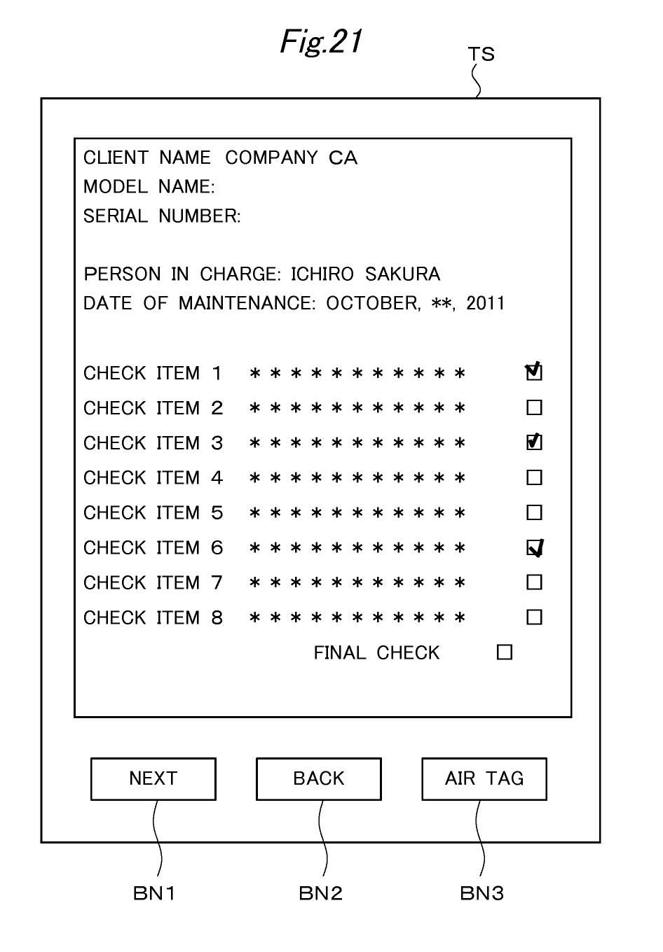

Specifically, the maintenance operator UA who has arrived in a location to which each image forming apparatus 10 was delivered (disposed) accesses the air tag information management server 50, using the personal digital assistant 70a. Then, the maintenance operator UA calls up an air tag information piece (e.g., AJ20) that corresponds to the current location determined by the GPS unit 71 of the personal digital assistant 70a. The maintenance operator UA further performs a predetermined operation with an air tag that corresponds to the air tag information piece AJ20 being displayed on the touch screen TS of the personal digital assistant 70a, so that a display screen of the content CN (specifically, image data) that is associated with the air tag can be displayed on the touch screen TS. Then, the maintenance operator UA enters a maintenance record on the maintenance sheet. For example, by performing a predetermined operation, it is possible to electronically write various types of recording information on a maintenance sheet displayed on the touch screen TS. For example, as illustrated in FIG. 21, a check mark or the like indicating that the check has been completed can be entered in check fields of a plurality of check items (on the right edge of the diagram).

This embodiment enables appropriate use of maintenance sheets. In particular, a maintenance operator can acquire information about the current location (GPS information), using the GPS unit 71 of the personal digital assistant 70 in the location where the maintenance target apparatus is disposed, and call up the air tag information piece that corresponds to the information about the current location (or maintenance sheet that corresponds to the information about the current location). That is, the maintenance operator can call up the maintenance sheet for each maintenance target apparatus while confirming the position using the position information (GPS information) of the maintenance target apparatus in front of him/her. It is thus possible to precisely and easily extract and provide a maintenance sheet that corresponds to each maintenance target apparatus. In particular, in the case of performing maintenance of a plurality of image forming apparatuses 10 delivered to a plurality of clients, it is possible to avoid mixing up the plurality of maintenance sheets.

### 4. Variations

While the above has been a description of embodiments of the present invention, the present invention is not intended to be limited to the above-described details.

For example, while in the above-described third embodiment, the case of adding an underline to the name (company name) of a client is given as an example, the present invention is not limited to this. Specifically, the model name and/or serial number of a maintenance target apparatus may be used as search keywords by adding underlines or the like to the model name and/or the serial number. In that case, the search for those search keywords may be performed based on information recorded in various items (including the comment field or the like) in the air tag management information DB1 (FIG. 17).

While in the above third embodiment, the case was described in which the position information PD is acquired based on a plurality of air tag information pieces that have already been registered in the air tag information management server 50 as in the second embodiment, the present invention is not limited thereto. For example, as in the first embodiment, position information that corresponds to a search keyword may be acquired based on a keyword information storage unit (more specifically, a customer information storage unit 5e (not shown) or the like in the image forming apparatus 10x) that is provided separately from the air tag information management server 50.

In this customer information storage unit 5e, for example, customer information or the like in which the name, address, and position information (GPS information) of the customer (client) are associated with one another may be stored. Then, an air tag information piece that corresponds to a search keyword (the company name of the client or the like) extracted from the content CN may be searched for, and position information PD included in that air tag information piece may be acquired as position information PD that corresponds to the search keyword. In this case, the position information PD corresponding to the search keyword is acquired based on data stored in the customer information storage unit 5e (stored data that associates the company name with the position information). This eliminates the need to register the air tag information piece corresponding to the company name in advance in the air tag management information DB1 of the air tag information management server 50.

While in the above-described first and second embodiments a mode in which the personal digital assistants 70 perform the registration operation (steps S11 to S14 and S21 to S24) was described, the present invention is not limited thereto. For example, the above-described first and second embodiments may be modified such that the MFP 10 performs the registration operation as in the third embodiment. Note that for this modification, the registration operation may be performed in the same MFP 10 in which the content is to be stored as in the above-described third embodiment. Alternatively, the registration operation may be performed by an MFP 10 different from the MFP 10 in which the content is to be stored.

Conversely, in the third embodiment, the personal digital assistant 70 may perform the registration operation (in particular, steps S31 to S34) as in the first and second embodiments.

While in the above-described embodiments the case was described in which the content CN is associated with the position information PD as image data that is generated by visualizing target document data for each page, the present invention is not limited thereto. For example, the content CN may be associated with the position information PD as data in the original format (e.g., data in a specific document file format (format of specific document preparation application)).

While in the above-described embodiments the case of using the personal digital assistant 70a as a personal digital assistant 70 was mainly given as an example, the present invention is not limited thereto, and another personal digital assistant 70 (e.g., 70b) may be used instead.

While in the above-described embodiments a mode was described in which search keywords are extracted from the content displayed on the display unit that is built into the personal digital assistant 70 (position-related information registration apparatus), the present invention is not limited thereto.

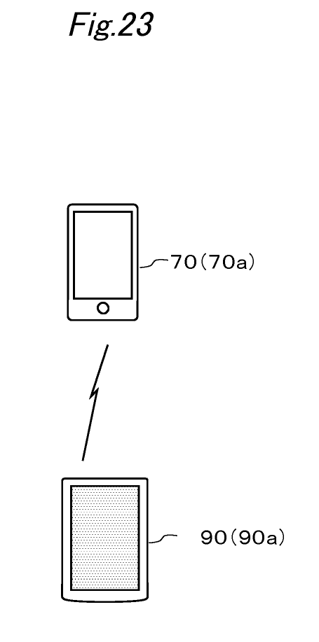

For example, search keywords may be extracted from the content displayed on a display unit (external display unit) that is connected to a personal digital assistant 70 (position-related information registration apparatus) (external connection (cable or wireless connection)). Specifically, as illustrated in FIG. 23, search keywords may be extracted from the content displayed on another display device 90 (90a) different from the personal digital assistant 70 (70a). The personal digital assistant 70 (70a) and the display device 90 (90a) may be connected using, for example, short-range wireless communication (Bluetooth (trademark)) so as to enable exchange of information therebetween. The display device 90 may be an electronic book reading apparatus (or a similar electronic paper reading apparatus) that has only a short-range communication function and does not have a function of network communication with the server 50. Then, an air tag information piece regarding the content in which the content is associated with position information acquired based on the search keyword, may be registered in the air tag information management server 50. In this way, the air tag information registration system (position-related information registration system) may be constituted by the personal digital assistant 70a, the display device 90a, and the like.

The present invention may be embodied in various other forms without departing from the spirit or essential characteristics thereof. The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

What is claimed is:

1. A position-related information registration and display system in which position-related information is registered in a position-related information management server on a network by a first data terminal, and an air tag based on the position-related information is displayable on a second data terminal that includes an imaging unit,
the first data terminal comprising:
a first display unit configured to display content to be registered;
an extraction unit configured to extract a search keyword from the content displayed on the first display unit;
a first acquisition unit configured to access a keyword information storage unit and acquire a corresponding position information piece that is a position information piece corresponding to the search keyword extracted from the content, the keyword information storage unit storing search keywords in association with position information pieces; and
a registration control unit configured to transmit a registration request in addition to the content and the corresponding position information piece to the position-related information management server, the registration request being a request to register information in which the content is associated with the corresponding position information piece as a position-related information piece regarding the content,
the position-related information management server comprising:
a reception unit configured to receive the position-related information piece in addition to the registration request from the first data terminal; and
a storage unit in which the position-related information piece that has been received is registered, and
the second data terminal comprising:
the imaging unit;
a second display unit configured to display a captured image obtained by the imaging unit;
a second acquisition unit configured to acquire a position-related information piece that corresponds to a location where the imaging unit performs imaging, from the position-related information management server; and
a display control unit configured to display an air tag in a superimposed manner in the captured image, the air tag being based on the position-related information piece acquired by the second acquisition unit.

2. The position-related information registration and display system according to claim 1, further comprising:
a geographic information management server,
the geographic information management server including
a geographic information storage unit storing geographic keywords in association with corresponding position information pieces that are position information pieces corresponding respectively to the geographic keywords,
wherein the extraction unit of the first data terminal is configured to extract a geographic keyword from the content displayed on the first display unit, and the first acquisition unit is configured to access the geographic information management server and acquire a corresponding position information piece that corresponds to the geographic keyword that has been extracted.

3. The position-related information registration and display system according to claim 2, wherein
the geographic keywords are geographic names.

4. The position-related information registration and display system according to claim 1, wherein
the display control unit of the second data terminal displays content that is associated with the position-related information piece acquired by the second acquisition unit, on the second display unit using the air tag.

5. The position-related information registration and display system according to claim 1, wherein
the first acquisition unit of the first data terminal acquires position information that is included in a position-related information piece that includes the search keyword among a plurality of position-related information pieces that have been registered in the position-related information management server, as the corresponding position information piece, from the position-related information management server, and
the registration control unit causes the position-related information management server to register information in which the content is associated with the corresponding position information piece, as a new position-related information piece regarding the content.

6. The position-related information registration and display system according to claim 5, wherein
the search keyword is a geographic name.

7. A position-related information registration system for registering position-related information in a position-related information management server, comprising:
a display unit configured to display content to be registered;
an extraction unit configured to extract a search keyword from the content displayed on the display unit;
an acquisition unit configured to access a keyword information storage unit and acquire a corresponding position information piece that is a position information piece corresponding to the search keyword extracted from the content, the keyword information storage unit storing search keywords in association with position information pieces; and
a registration control unit; configured to transmit a registration request in addition to the content and the corresponding position information piece to the position-related information management server, the registration request being a request to register information in which the content is associated with the corresponding position information piece as a position-related information piece regarding the content, and register the position-related information piece in the position-related information management server.

8. The position-related information registration system according to claim 7, wherein
the extraction unit is configured to extract a geographic keyword that is included in the content, as the search word.

9. The position-related information registration system according to claim 8, wherein
the keyword information storage unit storing geographic keywords in association with position information pieces, and
the acquisition unit is configured to acquire the corresponding position information piece, using the geographic keyword extracted by the extraction unit as the search keyword.

10. The position-related information registration system according to claim 7, wherein
the search keyword extracted from the content includes a geographic keyword, and
the acquisition unit is configured to transmit, to a geographic information management server, the geographic keyword extracted from the content and a search request for a position information piece that corresponds to the geographic keyword, and to acquire a position information piece that corresponds to the geographic keyword as the corresponding position information piece from the geographic information management server.

11. The position-related information registration system according to claim 7, wherein
the content includes data for recording a result of maintenance regarding a maintenance target apparatus,
the extraction unit is configured to extract, as the search keyword, a keyword that is specified in the content by a user and is at least one of a model, a serial number, and client name of the maintenance target apparatus, and
the acquisition unit is configured to access the keyword information storage unit and acquire the corresponding position information piece that corresponds to the search keyword.

12. A position-related information registration apparatus for registering position-related information in a position-related information management server, comprising:
an acquisition unit configured to access a keyword information storage unit and acquire a corresponding position information piece that is a position information piece corresponding to a search keyword that is extracted from content to be registered, the keyword information storage unit storing search keywords in association with position information pieces; and
a registration control unit configured to transmit a registration request in addition to the content and the corresponding position information piece to the position-related information management server, the registration request being a request to register information in which the content is associated with the corresponding position information piece as a position-related information piece regarding the content, and register the position-related information piece in the position-related information management server.

13. The position-related information registration apparatus according to claim 12, further comprising
an extraction unit configured to extract the search keyword from the content.

14. The position-related information registration apparatus according to claim 13, wherein
the extraction unit is configured to extract a geographic keyword that is included in the content as the search keyword.

15. The position-related information registration apparatus according to claim 14, wherein
the keyword information storage unit have geographic keywords stored in association with position information pieces, and
the acquisition unit is configured to acquire the corresponding position information piece, using the geographic keyword extracted by the extraction unit as the search keyword.

16. The position-related information registration apparatus according to claim 12, further comprising:
an extraction unit configured to extract the search keyword from content displayed on a display unit.

17. The position-related information registration apparatus according to claim 16, wherein
the display unit includes at least one of a display part that is built into the position-related information registration apparatus and a display part that is connected to the position-related information registration apparatus.

18. The position-related information registration apparatus according to claim 12, wherein
the search keyword extracted from the content includes a geographic keyword, and
the acquisition unit is configured to transmit, to a geographic information management server, the geographic keyword extracted from the content and a search request for a position information piece that corresponds to the geographic keyword, and to acquire a position information piece that corresponds to the geographic keyword as the corresponding position information piece from the geographic information management server.

19. The position-related information registration apparatus according to claim 13, wherein
the content includes data for recording a result of maintenance of a maintenance target apparatus,
the extraction unit is configured to extract, as the search keyword, a keyword that is specified in the content by a user and is at least one of a model, a serial number, and a client name of the maintenance target apparatus, and
the acquisition unit is configured to access the keyword information storage unit and acquire the corresponding position information piece that corresponds to the search keyword.

20. A non-transitory computer-readable recording medium that records a program for causing a computer to execute the steps of:
a) accessing a keyword information storage unit and acquiring a corresponding position information piece that is a position information piece corresponding to a search keyword extracted from content to be registered, the keyword information storage unit storing search keywords in association with position information pieces; and
b) transmitting a registration request in addition to the content and the corresponding position information piece to a position-related information management server, the registration request being a request to register information in which the content is associated with the corresponding position information piece as a position-related information piece regarding the content, and registering the position-related information piece in the position-related information management server.

21. A position-related information registration system for registering position-related information in a position-related information management server, comprising:
a display unit configured to display content to be registered;
an extraction unit configured to extract a search keyword from the content displayed on the display unit;
a transmission unit configured to transmit a search request in addition to the search keyword to the position-related information management server, the search request being a request to search for a corresponding position information piece that is a position information piece corresponding to the search keyword extracted from the content;
an acquisition unit configured to, based on a search result from the position-related information management server, acquire position information that is included in a position-related information piece that contains the search keyword among a plurality of position-related information pieces that have been registered in the position-related information management server, as the corresponding position information piece; and
a registration control unit configured to transmit a registration request in addition to the content and the corresponding position information piece to the position-related information management server, the registration request being a request to register information in which the content is associated with the corresponding position information piece as a new position-related information piece regarding the content, and register the new position-related information piece in the position-related information management server.

22. The position-related information registration system according to claim 21, wherein
the extraction unit is configured to extract the search keyword from the content, based on a specific mark that is given by an operator to a desired character area in the content.

23. The position-related information registration system according to claim 21, wherein
the content includes data for recording a result of maintenance of a maintenance target apparatus,
the position-related information pieces that have been registered in the position-related information management server include a position-related information piece that associates the maintenance target apparatus with position information regarding a location of a client to which the maintenance target apparatus is delivered,
the extraction unit is configured to extract, as the search keyword, a keyword that is specified in the content by a user and that is at least one of a model, a serial number, and a client name of the maintenance target apparatus, and
the acquisition unit is configured to access the position-related information management server, acquire a position-related information piece that corresponds to the search keyword from among the position-related information pieces that have been registered in the position-related information management server, and acquire position information that is included in the position-related information piece that has been acquired, as the corresponding position information piece.

24. A position-related information registration apparatus for registering position-related information in a position-related information management server, comprising:
a transmission unit configured to transmit a search request in addition to a search keyword that is extracted from content to be registered to the position-related information management server, the search request being a request to search for a corresponding position information piece that is a position information piece corresponding to the search keyword;
an acquisition unit configure to, based on a search result from the position-related information management server, acquire position information that is included in a position-related information piece that contains the search keyword among a plurality of position-related information pieces that have been registered in the position-related information management server, as the corresponding position information piece; and
a registration control unit configured to transmit a registration request in addition to the content and the corresponding position information piece to the position-related information management server, the registration request being a request to register information in which the content is associated with the corresponding position information piece as a new position-related information piece regarding the content, and register the new position-related information piece in the position-related information management server.

25. The position-related information registration apparatus according to claim 24, further comprising
an extraction unit configured to extract a search keyword from the content.

26. The position-related information registration apparatus according to claim 25, wherein
the extraction unit is configured to extract the search keyword from the content, based on a specific mark that is given by an operator to a desired character area in the content.

27. The position-related information registration apparatus according to claim 24, further comprising
an extraction unit configured to extract the search keyword from content that is displayed on a display unit.

28. The position-related information registration apparatus according to claim 27, wherein
the display unit includes at least one of a display part that is built into the position-related information registration apparatus and a display part that is connected to the position-related information registration apparatus.

29. The position-related information registration apparatus according to claim 24, wherein
the content includes data for recording a result of maintenance of a maintenance target apparatus,
the position-related information pieces that have been registered in the position-related information management server include a position-related information piece that associates the maintenance target apparatus with position information of a client to which the maintenance target apparatus is delivered,
the extraction unit is configured to extract, as the search keyword, a keyword that is specified in the content by a user and is at least one of a model, a serial number, and a client name of the maintenance target apparatus, and
the acquisition unit is configured to access the position-related information management server, acquire a position-related information piece that corresponds to the search keyword from among the position-related information pieces that have been registered in the position-related information management server, and acquire position information that is included in the position-related information piece that has been acquired, as the corresponding position information piece.

30. A non-transitory computer-readable recording medium that records a program for causing a computer to execute the steps of:
a) transmitting a search request in addition to a search keyword that is extracted from content to be registered to the position-related information management server, the search request being a request to search for a corresponding position information piece that is a position information piece corresponding to the search keyword;
b) based on a search result from the position-related information management server, acquiring position information that is included in a position-related information piece that contains the search keyword among a plurality of position-related information pieces that have been registered in the position-related information management server, as the corresponding position information piece; and
c) transmitting a registration request in addition to the content and the corresponding position information piece to the position-related information management server, the registration request being a request to register information in which the content is associated with the corresponding position information piece as a new position-related information piece regarding the content, and registering the new position-related information piece in the position-related information management server.
